(19) United States
(12) Patent Application Publication
(10) Pub. No.: US 2026/0292247 A1
(43) Pub. Date: Sep. 24, 2026

(54) VIDEO DECODING METHOD, VIDEO ENCODING METHOD, DECODER, ENCODER, DEVICE, AND MEDIUM

(71) Applicant: Tencent Technology (Shenzhen) Company Limited, Shenzhen (CN)

(72) Inventors: Yingbin WANG, Shenzhen (CN); Xiaozhong Xu, Shenzhen (CN)

(21) Appl. No.: 19/695,919

(22) Filed: Jun. 2, 2026

Related U.S. Application Data
(63) Continuation of application No. PCT/CN2024/131397, filed on Nov. 11, 2024.

(30) Foreign Application Priority Data
Dec. 10, 2023 (CN) 202311702301.4

(51) Int. Cl. H04N 19/593; H04N 19/105; H04N 19/159; H04N 19/176; H04N 19/70

(52) U.S. Cl. CPC H04N 19/593; H04N 19/105; H04N 19/159; H04N 19/176; H04N 19/70

(57) ABSTRACT

This application relates to the field of video encoding and decoding technologies, and provides a video decoding method, a video encoding method, a decoder, an encoder, an electronic device, and a computer-readable storage medium. The decoding method includes: parsing a code stream to determine a target block, in accordance with a determination that a prediction mode of the target block is intra block copy (IBC) prediction; determining target prediction information of the target block based on reconstruction information of an adjacent region of the target block and original prediction information of the target block; and determining reconstruction information of the target block based on the target prediction information. According to the solution of this application, reconstruction information of a surrounding region of the target block is added to the target prediction information, which facilitates smooth transition between the target block and the surrounding region thereof.

### CROSS-REFERENCE TO RELATED APPLICATIONS

This application is a continuation application of PCT Patent Application No. PCT/CN2024/131397, entitled “VIDEO DECODING METHOD, VIDEO ENCODING METHOD, DECODER, ENCODER, DEVICE, AND MEDIUM” filed on Nov. 11, 2024, which claims priority to Chinese Patent Application No. 202311702301.4, entitled “VIDEO DECODING METHOD, VIDEO ENCODING METHOD, DECODER, ENCODER, DEVICE, AND MEDIUM” and filed with the China National Intellectual Property Administration on Dec. 10, 2023, all of which are incorporated herein by reference in their entirety.

### FIELD OF THE TECHNOLOGY

Embodiments of this application relate to the field of video encoding and decoding technologies, and in particular, to a video decoding method, a video encoding method, a decoder, an encoder, an electronic device, and a computer-readable storage medium.

### BACKGROUND OF THE DISCLOSURE

In the related art, video coding standards such as high efficiency video coding (HEVC), versatile video coding (VVC), and audio video coding standard (AVS) 3 all use a hybrid encoding framework based on a picture block. An original frame of picture is divided into a series of picture blocks, and video data is compressed through video encoding methods such as prediction, transform, and entropy coding. Motion compensation is a type of prediction method commonly used in video coding and decoding. The motion compensation determines a predicted value of a current to-be-encoded block based on a redundancy feature of video content in a time domain or a space domain according to a reference block. The type of prediction methods based on the motion compensation include inter prediction, intra block copy (IBC), intra string copy, and the like.

The IBC is an intra coding tool adopted in a screen content coding (SCC) extension of the HEVC. In the related art, a problem of poor space domain continuity between a picture block reconstructed through the IBC and a surrounding pixel exists, which affects picture quality and does not help improve encoding and decoding performance.

### SUMMARY

This application provides a video decoding method, a video encoding method, a decoder, an encoder, and a computer-readable storage medium, to reduce space domain discontinuity between a prediction block and a surrounding pixel at least to some extent, thereby helping improve picture quality and encoding and decoding performance.

According to a first aspect, this application provides a video decoding method, the method including: parsing a code stream to determine a target block, in accordance with a determination that a prediction mode of the target block is intra block copy (IBC) prediction: determining target prediction information of the target block based on reconstruction information of an adjacent region of the target block and original prediction information of the target block; and determining reconstruction information of the target block based on the target prediction information.

According to a second aspect, this application provides a video encoding method, the method including: determining a target block, a prediction mode of the target block being IBC prediction; determining target prediction information of the target block based on reconstruction information of an adjacent region of the target block and original prediction information of the target block; and determining reconstruction information of the target block based on the target prediction information.

According to a third aspect, this application provides a decoder. The decoder includes a first determining module, a second determining module, and a third determining module.

The foregoing first determining module is configured to parse a code stream, and determine a target block, a prediction mode of the target block being IBC prediction. The foregoing second determining module is configured to determine target prediction information of the target block based on reconstruction information of an adjacent region of the target block and original prediction information of the target block. The foregoing third determining module is configured to determine reconstruction information of the target block based on the target prediction information.

According to a fourth aspect, this application provides an encoder. The encoder includes a first determining module, a second determining module, and a third determining module.

The foregoing first determining module is configured to determine a target block, a prediction mode of the target block being IBC prediction. The foregoing second determining module is configured to determine target prediction information of the target block based on reconstruction information of an adjacent region of the target block and original prediction information of the target block. The foregoing third determining module is configured to determine reconstruction information of the target block based on the target prediction information.

According to a fifth aspect, an electronic device is provided, including a processor and a memory. The memory is configured to store a computer program, and the processor is configured to invoke and run the computer program stored in the memory, to perform the foregoing method in the first aspect or the second aspect and implementations thereof.

According to a sixth aspect, a chip is provided, configured to implement the foregoing method in any one of the first aspect or implementations thereof. Specifically, the chip includes a processor, configured to invoke and run a computer program from a memory, so that a device installed with the chip performs the foregoing method in the first aspect or the second aspect and implementations thereof.

According to a seventh aspect, a non-transitory computer-readable storage medium is provided, storing a code stream that is configured to be decoded or encoded by the foregoing method in the first aspect or the second aspect and implementations thereof.

According to an eighth aspect, a computer program product is provided, including a computer program instruction. The computer program instruction causes a computer to perform the foregoing method in the first aspect or the second aspect and implementations thereof.

According to a ninth aspect, a computer program is provided. The computer program, when run on a computer, causes the computer to perform the foregoing method in the first aspect or the second aspect and implementations thereof.

Based on the above, for a target block whose prediction mode is IBC prediction, if the reconstructed block is obtained based on the original prediction information of the target block, a discontinuous boundary may exist on the reconstructed block. Consequently, poor space domain continuity between the block and surrounding pixels thereof may exist. In the embodiments of this application, the target prediction information of the target block is jointly determined based on the reconstruction information of the adjacent region of the target block and the original prediction information of the target block. Reconstruction information of a surrounding region of the target block is added to the target prediction information, which facilitates smooth transition between the target block and the surrounding region thereof, thereby helping reduce space domain discontinuity between the target block and the surrounding region thereof, improving picture quality, and helping improve encoding and decoding performance.

### BRIEF DESCRIPTION OF THE DRAWINGS

FIG. 1 is an example diagram of a structure of a video encoder according to an embodiment of this application;

FIG. 2 is an example diagram of a structure of a video decoder according to an embodiment of this application;

FIG. 3 is an example diagram of an intra block copy (IBC) prediction mode according to an embodiment of this application;

FIG. 4 is a schematic diagram of a slice-level syntactic structure in a code stream according to an embodiment of this application;

FIG. 5 is a schematic flowchart of a video decoding method according to an embodiment of this application;

FIG. 6 is a schematic flowchart of a method for determining a target block according to an embodiment of this application;

FIG. 7 is a schematic flowchart of a method for determining a target block according to another embodiment of this application;

FIG. 8 is a schematic flowchart of a method for determining a target block according to yet another embodiment of this application;

FIG. 9 is a schematic flowchart of a method for determining a target block according to another embodiment of this application;

FIG. 10 is a schematic flowchart of a method for determining a target block according to still another embodiment of this application;

FIG. 11 is a schematic flowchart for determining target prediction information according to an embodiment of this application;

FIG. 12 is a schematic structural diagram of a target block and an adjacent region thereof according to an embodiment of this application;

FIG. 13 is a schematic flowchart for determining target prediction information according to another embodiment of this application;

FIG. 14 is a schematic flowchart of a video encoding method according to an embodiment of this application;

FIG. 15 is a schematic structural diagram of a decoder according to an embodiment of this application;

FIG. 16 is a schematic structural diagram of an encoder according to an embodiment of this application;

FIG. 17 is a schematic structural diagram of a codec system according to an embodiment of this application; and

FIG. 18 is a schematic structural diagram of an electronic device according to an embodiment of this application.

### DESCRIPTION OF EMBODIMENTS

Technical solutions in embodiments of this application are clearly and completely described below with reference to accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

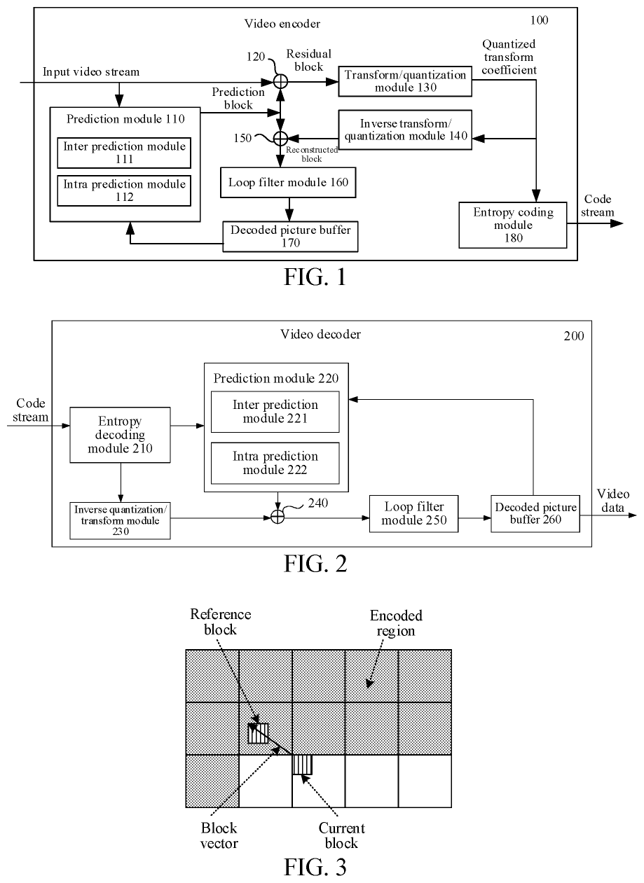

FIG. 1 is an example diagram of a structure of a video encoder 100 according to an embodiment of this application. The video encoder 100 may be configured to perform lossy compression on a picture, or may be configured to perform lossless compression on a picture. The lossless compression may be visually lossless compression, or may be mathematically lossless compression.

The video encoder 100 may be applied to picture data in a luminance and chrominance (YCbCr, YUV) format. For example, a YUV ratio may be 4:2:0, 4:2:2, or 4:4:4, where Y represents the luminance (Luma), Cb (U) represents blue chrominance, Cr (V) represents red chrominance, and U and V represent chroma for describing colors and saturation. For example, in a color format, 4:2:0 represents that every 4 pixels have 4 luminance components and 2 chrominance components (YYYYCbCr), 4:2:2 represents that every 4 pixels have 4 luminance components and 4 chrominance components (YYYYCbCrCbCr), and 4:4:4 represents full pixel display (YYYYCbCrCbCrCbCrCbCr).

For example, the video encoder 100 reads video data. For each picture in the video data, a picture is divided into several coding tree units (CTU). In some examples, the CTU may be referred to as a “tree block”, a “largest coding unit (LCU)”, or a “coding tree block (CTB)”. Each CTU may be associated with pixel blocks having equal sizes in the picture. Each pixel may correspond to one luminance (or luma) sample and two chrominance (or chroma) samples. Therefore, each CTU may be associated with one luminance sampling block and two chrominance sampling blocks. A size of one CTU is, for example, 128×128, 64×64, and 32×32. One CTU may further be divided into several coding units (CU) for encoding. The CU may be a rectangular block or a square block. The CU may correspond to a prediction unit (PU) and a transform unit (TU).

Referring to FIG. 1, the video encoder 100 may include a prediction module 110, a residual module 120, a transform/quantization module 130, an inverse transform/quantization module 140, a reconstruction module 150, a loop filter module 160, a decoded picture buffer 170, and an entropy coding module 180. The video encoder 100 may include more, fewer, or different functional components.

In some embodiments, in this application, a current block may be referred to as a current CU. A prediction block may alternatively be referred to as a predicted picture block or a picture prediction block, and a reconstructed picture block may alternatively be referred to as a reconstructed block or a picture reconstructed block. Due to a requirement of parallel processing, the picture may be divided into slices. Slices in the same picture may be processed in parallel. In other words, no data dependency exists therebetween. However, “frame” is a commonly used expression, and may generally be understood as that a frame is a picture. In this specification, the frame may alternatively be replaced with a picture, a slice, or the like.

In some embodiments, the prediction module 110 includes an inter prediction module 111 and an intra prediction module 112. Due to a strong correlation between adjacent pixels in a picture of a video, in a video coding and decoding technology, spatial redundancy between adjacent pixels is eliminated through an intra prediction method. Due to a strong similarity between adjacent pictures in the video, in the video coding and decoding technology, temporal redundancy between adjacent pictures is eliminated through an inter prediction method, thereby improving encoding efficiency.

The inter prediction module 111 may be configured for inter prediction. The inter prediction may include motion estimation and motion compensation, which may refer to picture information of different pictures. The inter prediction uses motion information to find a reference block from a reference picture, and generates a prediction block based on the reference block, to eliminate the temporal redundancy. The inter prediction uses motion information to find the reference block from the reference picture, and generates a prediction block based on the reference block. The motion information includes a reference picture list in which the reference picture is located, a reference picture index, and a motion vector. The motion vector may be either integer-pixel or fractional-pixel. If the motion vector is fractional-pixel, a required fractional-pixel block needs to be made in the reference picture through interpolation filtering. The integer-pixel or fractional-pixel block in the reference picture found based on the motion vector is referred to as the reference block herein. In some technologies, the reference block is directly used as the prediction block. In some technologies, the prediction block is generated through further processing based on the reference block. Generating the prediction block through further processing based on the reference block may alternatively be understood as using the reference block as a prediction block and then processing based on the prediction block to generate a new prediction block.

The intra prediction module 112 only refers to information of the same picture to predict pixel information in a current code picture block, to eliminate the spatial redundancy.

The intra prediction has a plurality of prediction modes. Using an international digital video coding standard H series as an example, the H.264/AVC standard has 8 angle prediction modes and 1 non-angle prediction mode, and the H.265/HEVC extends to 33 angle prediction modes and 2 non-angle prediction modes. The intra prediction modes used in the HEVC include a planar mode, a direct current (DC) mode, and 33 angle modes, totaling 35 prediction modes. The intra prediction modes used in versatile video coding (VVC) include a planar mode, a DC mode, and 65 angle modes, totaling 67 prediction modes.

With the increase of angle modes, the intra prediction is more accurate and better conforms to requirements for the development of high-definition and ultra-high-definition digital videos.

The residual module 120 may generate a residual block of the CU based on the pixel block of the CU and the prediction block of the CU. For example, the residual module 120 may generate the residual block of the CU, so that each sample in the residual block has a value equal to a difference between a sample in the pixel block of the CU and a corresponding sample in the prediction block of the CU.

The transform/quantization module 130 may quantize a transform coefficient. The transform/quantization module 130 may quantize a transform coefficient associated with the CU based on a quantization parameter (QP) value associated with the CU. The video encoder 100 may adjust a quantization degree applied to the transform coefficient associated with the CU by adjusting the QP value associated with the CU.

The inverse transform/quantization module 140 may apply inverse quantization and inverse transform to the quantized transform coefficient to reconstruct a residual block from the quantized transform coefficient.

The reconstruction module 150 may add samples of the reconstructed residual block to corresponding samples of one or more prediction blocks generated by the prediction module 110, so as to generate a reconstructed picture block associated with the CU. In this way, each sampling block of the CU is reestablished, and the video encoder 100 may reconstruct a pixel block of the CU.

The loop filter module 160 is configured to process pixels obtained after inverse transform and inverse quantization to compensate for distortion information and provide a better reference for subsequently encoding pixels. For example, a deblocking filter operation may be performed to reduce blocking effects of pixel blocks associated with the CU.

In some embodiments, the loop filter module 160 includes a deblocking filter module and a sample adaptive offset/adaptive loop filter (SAO/ALF) module, where the deblocking filter module is configured to eliminate a blocking effect, and the SAO/ALF module is configured to eliminate a ringing effect.

The decoded picture buffer 170 may store a reconstructed pixel block. The inter prediction module 111 may perform inter prediction on a PU of another picture through a reference picture including the reconstructed pixel block. In addition, the intra prediction module 112 may perform intra prediction on another PU in the same picture as the CU through the reconstructed pixel block in the decoded picture buffer 170.

The entropy coding module 180 may receive the quantized transform coefficient from the transform/quantization module 130. The entropy coding module 180 may perform one or more entropy coding operations on the quantized transform coefficient to generate entropy-encoded data.

FIG. 2 is a schematic structural diagram of a video decoder 200 according to an embodiment of this application. Referring to FIG. 2, the video decoder 200 includes an entropy decoding module 210, a prediction module 220, an inverse quantization/transform module 230, a reconstruction module 240, a loop filter module 250, and a decoded picture buffer 260. The video decoder 200 may include more, fewer, or different functional components.

The video decoder 200 may receive a code stream. The entropy decoding module 210 may parse the code stream to extract a syntax element from the code stream. As a portion of parsing the code stream, the entropy decoding module 210 may parse an entropy-encoded syntax element in the code stream. The prediction module 220, the inverse quantization/transform module 230, the reconstruction module 240, and the loop filter module 250 may decode the video data based on the syntax element extracted from the code stream, to generate decoded video data.

In some embodiments, the prediction module 220 includes an intra prediction module 222 and an inter prediction module 221.

The intra prediction module 222 may perform intra prediction to generate a prediction block of a PU. The intra prediction module 222 may use an intra prediction mode to generate the prediction block of the PU based on a pixel block of a spatially adjacent PU. The intra prediction module 222 may further determine the intra prediction mode of the PU based on one or more syntax elements parsed from the code stream.

The inter prediction module 221 may construct a first reference picture list (a list 0) and a second reference picture list (a list 1) based on the syntax element parsed from the code stream. In addition, if the PU uses the inter prediction coding, the entropy decoding module 210 may parse motion information of the PU. The inter prediction module 221 may determine one or more reference blocks of the PU based on the motion information of the PU. The inter prediction module 221 may generate a prediction block of the PU based on one or more reference blocks of the PU.

The inverse quantization/transform module 230 may perform inverse quantization (i.e., dequantization) on a transform coefficient associated with the TU. The inverse quantization/transform module 230 may determine a quantization degree by using a QP value associated with the CU of the TU.

After the inverse quantization is performed on the transform coefficient, the inverse quantization/transform module 230 may apply one or more inverse transforms to an inverse-quantized transform coefficient to generate a residual block associated with the TU.

The reconstruction module 240 reconstruct a pixel block of the CU by using the residual block associated with the TU of the CU and the prediction block of the PU of the CU. For example, the reconstruction module 240 may add a sample of the residual block to a corresponding sample of the prediction block to reconstruct a pixel block of the CU, thereby obtaining a reconstructed picture block.

The loop filter module 250 may perform a deblocking filter operation to reduce blocking effects of pixel blocks associated with the CU.

The video decoder 200 may store a reconstructed picture of the CU in the decoded picture buffer 260. The video decoder 200 may use the reconstructed picture in the decoded picture buffer 260 as a reference picture for subsequent prediction, or transmit the reconstructed picture to a display apparatus for presentation.

A basic process of video coding and decoding is as follows. At an encoder side, a picture is divided into blocks. For a current block, the prediction module 110 generates a prediction block of the current block by using intra prediction or inter prediction. The residual module 120 may calculate a residual block based on the prediction block and an original block of the current block, i.e., a difference between the prediction block and the original block of the current block. The residual block may also be referred to as residual information. The residual block is transformed and quantized by the transform/quantization module 130, so that information insensitive to human eyes may be removed to eliminate visual redundancy. In some embodiments, a residual block before being transformed and quantized by the transform/quantization module 130 may be referred to as a time-domain residual block, and a time-domain residual block after being transformed and quantized by the transform/quantization module 130 may be referred to as a frequency residual block or a frequency-domain residual block. The entropy coding module 180 receives a quantized transform coefficient output by the transform/quantization module 130, and may perform entropy encoding on the quantized transform coefficient to output a code stream. For example, the entropy coding module 180 may eliminate character redundancy based on a target context model and probability information of a binary code stream.

At a decoder side, the entropy decoding module 210 may parse the code stream to obtain prediction information, a quantization coefficient matrix, and the like of the current block. The prediction module 220 performs intra prediction or inter prediction on the current block based on the prediction information, to generate a prediction block of the current block. The inverse quantization/transform module 230 performs inverse quantization and inverse transform on the quantization coefficient matrix through the quantization coefficient matrix obtained from the code stream, to obtain a residual block. The reconstruction module 240 adds the prediction block and the residual block to obtain a reconstructed block. The reconstructed blocks form a reconstructed picture, and the loop filter module 250 performs loop filtering on the reconstructed picture based on the picture or the block, to obtain a decoded picture. The encoder side also needs an operation similar to that of the decoder side to obtain the decoded picture. The decoded picture may also be referred to as the reconstructed picture, and the reconstructed picture may be a subsequent picture used as the reference picture for inter prediction.

Block division information determined by the encoder side, and mode information or parameter information such as prediction, transform, quantization, entropy encoding, loop filtering, and the like are carried in the code stream when necessary. The decoder side parses the code stream and analyzes the code stream based on existing information to determine block division information, and mode information or parameter information such as prediction, transform, quantization, entropy encoding, loop filtering, and the like that are the same as that of the encoder side, thereby ensuring that the decoded picture obtained by the encoder side is the same as the decoded picture obtained by the decoder side.

The “inverse transform” performed by the decoder side on the transform coefficient may alternatively be referred to as “transform” in a standard text. In the embodiments of this application, “transform” and “inverse transform” correspond to two opposite processes. For example, “transform” converts a numerical value in a space domain into a coefficient in a frequency domain, and “inverse transform” converts a coefficient in a frequency domain into a numerical value in a space domain. If only decoding is specified in the standard, “transform” in the standard text is a portion of decoding, and refers to “inverse transform” in this specification. The “inverse transform” performed by the decoder side on the transform coefficient may alternatively be referred to as “transform” in a standard text.

Video encoding standards such as HEVC, VVC, AVS3, alliance for open media video 2 (AV2), and alliance for open media video 1 (AV1) all use the foregoing hybrid coding framework based on a block. With the development of technologies, some modules or operations of the framework or the process may be optimized. This application is applicable to the basic process of the video codec in the block-based hybrid coding framework, but is not limited to the framework and the process.

As described above, motion compensation is a common type of prediction mode for video coding, and may include an inter prediction mode, an intra block copy (IBC) prediction mode, an intra string copy prediction mode, and the like. In specific coding implementation, these prediction modes may be used alone or in combination. For a coding block using these prediction modes, one or more two-dimensional displacement vectors are required to explicitly or implicitly encode in a code stream, which indicates displacement of a current block (or a co-located block of the current block) relative to one or more reference blocks of the current block. In different prediction modes and in different implementations, the displacement vector may have different names. For example: 1) A displacement vector in inter prediction is referred to as a motion vector (MV for short); 2) A displacement vector in IBC is referred to as a block vector (BV for short); and 3) A displacement vector in intra string copy is referred to as a string vector (SV for short).

This application relates to the IBC prediction mode. The following describes the related art of the IBC prediction mode.

FIG. 3 is an example diagram of an IBC prediction mode according to an embodiment of this application. In the IBC prediction mode, a reconstructed region of a current frame is used as reference to export a predicted value of the current block. Referring to FIG. 3, a shadow region is a region on which coding and reconstruction have been performed. A reference block of a to-be-encoded current encoding block is determined in an encoded region. Specifically, displacement between the current block and the reference block thereof is a BV of the current block. The IBC prediction mode is to predict a pixel of a current to-be-encoded block through correlation of a screen content video in the spatial domain by using an encoded picture pixel on a current picture, which can effectively save bits required for coding pixels. In the AVS3, the VVC, and the AV1, an IBC technology is also adopted to improve performance of screen content encoding (SCC).

In the related art, a prediction block obtained by using the IBC mode easily has a discontinuous boundary, namely, a transition between a reconstructed block and surrounding pixels is unnatural, and a problem of poor space domain continuity exists, which affects picture quality and does not help improve encoding and decoding performance.

For the foregoing problem existing in the related art, the technical solution is provided in the embodiments of this application. In the embodiments of this application, for a target block whose prediction mode is IBC prediction, target prediction information of the target block is jointly determined based on reconstruction information of an adjacent region of the target block and original prediction information of the target block. Reconstruction information of a surrounding region of the target block is added to the target prediction information, which facilitates smooth transition between the target block and the surrounding region thereof, thereby helping reduce space domain discontinuity between the target block and the surrounding region thereof, improving picture quality, and helping improve encoding and decoding performance.

Terms intensively involved in an IBC tool are as follows.

SIBC: Symmetric Intra Block Copy, a mirror block copy intra prediction mode

RRIBC: Reconstruction-Reordered IBC, block copy intra prediction mode based on reconstruction value reversion

FIBC: Filtered Intra Block Copy, block copy intra prediction filtering

IBC-PC: IBC-Prediction Correction, inter prediction correction

IBC-LIC: IBC with Local Illumination Compensation, block copy intra prediction with local illumination compensation

IBC-MBVD: IBC merge mode with block vector differences, an IBC merge mode with block vector residual

IBC-TM: IBC with Template Matching, an IBC mode with template matching

IBC-TM-AMVP: IBC with Template Matching, IBC in an AMVP mode with template matching

IBC-TM-MRG: IBC with Template Matching, IBC in a merge mode with template matching

IBC-CIIP: Combined intra block copy and intra prediction, IBC and intra prediction merge mode

IBC-GPM: IBC with Geometry Partitioning, an IBC mode with geometry partitioning

Before the embodiments of this application are formally described, a syntax level of an encoded bit stream is described.

### 1. Video Sequence

A video sequence is a top-level syntactic structure of a bit stream. The video sequence starts with a first sequence header, and a sequence ending code or a video editing code indicates an end of the video sequence. A sequence header between the first sequence header of the video sequence and a first sequence ending code or the video editing code is a repeated sequence header. Each sequence header is followed by one or more encoded pictures, and each picture is to be preceded by a picture header. The encoded pictures are arranged in a bit stream order in the bit stream, and the bit stream order is to be the same as a decoding order. The decoding order may not be the same as a display order.

### 2. Picture Frame

A picture may be a frame or a field, and encoded data of the picture starts with a picture start code and ends with a sequence start code, a sequence ending code, or a next picture start code. In a bit stream, encoded data of the two fields of an interlaced scan a picture may appear sequentially, or may appear in a mixed manner. Decoding and display orders of the two fields of data are specified in the picture header. The picture type includes a picture I, a picture P, and a picture B.

### 3. Slice

A slice is a rectangular region in a picture, and includes a portion of several LCUs in the picture. Slices do not overlap with each other. For a slice structure, reference is made to a slice structure A-a partial structure F in FIG. 4.

### 4. LCU, Coding Tree, and CU

A picture is divided into LCUs, the LCUs do not overlap each other, a sample at an upper left corner of the LCU does not exceed a picture boundary, and a sample at a lower right corner of the LCU may exceed a picture boundary.

The LCU is divided into one or more CUs, which is determined by a coding tree. The CU is divided into one or more transform blocks.

Before the embodiments of this application are formally described, descriptions related to descriptions of the bit stream are described.

### 1. Description Method

A bit stream syntax description method is similar to a C language. Syntax elements of a bit stream are represented through bold characters, and each syntax element is described through a name (an English letter group divided by using an underline, where all letters are lowercase), syntax, and semantics. Values of syntax elements in a syntax table and a main text are represented by using normal fonts.

In some cases, another variable value exported from syntax elements may be applied in a syntax table, and such a variable is named through a mixture of lowercase letters and capital letters without underline in the syntax table or the main text. A variable starting from a capital letter is configured for decoding a current and related syntactic structure, and may also be configured for decoding a subsequent syntactic structure. A variable starting with a lowercase letter is used only in a section in which the variable is located.

A relationship between a mnemonic symbol of a syntax element value and a mnemonic symbol of a variable value and the values thereof is described in the main text. In some cases, the two are used equivalently. The mnemonic symbol is represented by one or more letter groups separated by using an underline. Each letter group starts with a capital letter, or may include a plurality of capital letters.

### 2. Descriptor

A descriptor represents a parsing process of different syntax elements. See the following table.

| Descriptor | Description |
|---|---|
| ae(v) | A syntax element of advanced entropy encoding. |
| u(n) | An n-bit unsigned integer. In the syntax table, |
| | if n is “v”, the bit quantity thereof is determined |
| | by a value of another syntax element. A parsing process |
| | is stipulated by a return value of the function |
| | read_bits(n), and the return value is represented by a |
| | binary bit at a high order. |
| ue(v) | An unsigned integer syntax element is encoded by |
| | using an exponential Golomb code. |

The technical solutions in the embodiments of this application are described in detail below by using some embodiments. The following embodiments may be combined with each other, and same or similar concepts or processes may not be repeated in some embodiments.

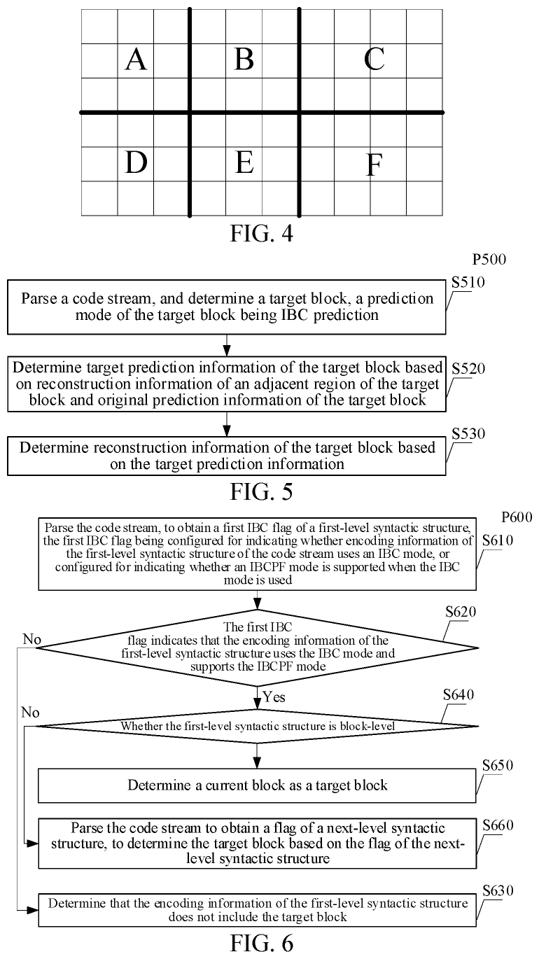

FIG. 5 is a schematic flowchart of a video decoding method P500 according to an embodiment of this application. The method P500 is performed by a decoder that may decode a code stream, for example, an electronic device having a decoding function. Referring to FIG. 5, the method P500 includes S510 to S530.

S510: Parse a code stream, and determine a target block, a prediction mode of the target block being IBC prediction.

The foregoing target block is a current CU. In this embodiment of this application, the foregoing target block is a CU obtained through prediction by using an IBC prediction mode. Further, in this embodiment of this application, because original prediction information of the target block is filtered, the foregoing target block in this embodiment of this application needs to further support an intra block copy prediction filter (IBCPF).

In this embodiment of this application, whether the current block is the foregoing target block may be explicitly determined based on a flag related to an IBC mode and/or an IBCPF mode. The following describes an embodiment of how to display and determine the target block based on the foregoing flag with reference to embodiments provided in FIG. 6 to FIG. 10.

FIG. 6 is a schematic flowchart of a method P600 for determining a target block according to an embodiment of this application. The embodiment shown in the figure may be used as a specific implementation of S510. Referring to FIG. 6, the embodiment shown in the figure includes S610-S660.

S610: Parse the code stream, to obtain a first IBC flag of a first-level syntactic structure, the first IBC flag being configured for indicating whether encoding information of the first-level syntactic structure of the code stream uses an IBC mode, or configured for indicating whether an intra block copy prediction filter (IBCPF) mode is supported when the IBC mode is used.

As described above, syntax levels of the encoded bit stream include sequence-level, frame-level, slice-level, block-level, and the like. In the embodiments of this application, the foregoing first-level syntactic structure may be any one of the sequence-level, the frame-level, the slice-level, and the block-level.

S620: Determine whether the first IBC flag indicates that the encoding information of the first-level syntactic structure uses the IBC mode and supports the IBCPF mode.

When the first IBC flag indicates that the encoding information of the first-level syntactic structure does not use the IBC mode, or when the first IBC flag indicates that the encoding information of the first-level syntactic structure uses the IBC mode and does not support the IBCPF mode, S630 of determining that the encoding information of the first-level syntactic structure does not include the target block is performed.

When the first IBC flag indicates that the encoding information of the first-level syntactic structure uses the IBC mode and supports the IBCPF mode, S640 of determining whether the first-level syntactic structure is block-level is performed.

When the first-level syntactic structure is block-level, S650 of determining a current block as the target block is performed.

When the first-level syntactic structure is not block-level, S660 of parsing the code stream to obtain a flag of a next-level syntactic structure, to determine the target block based on the flag of the next-level syntactic structure is performed.

Embodiment 1 of the method P600: The foregoing first-level syntactic structure is sequence-level. It is assumed that the foregoing first IBC flag may be represented as seq_ibc_flag. Semantic information respectively represented by different values of seq_ibc_flag is shown in Table 1.

TABLE 1

| seq_ibc_flag | Semantics |
|---|---|
| 0 | Use of the IBC mode is not allowed |
| 1 | Use of the IBC mode is allowed, but use of the |
| | IBCPF mode is not allowed |
| 2 | Use of the IBC mode and the IBCPF mode is allowed |

A syntactic structure of Table 1 is:

| | |
|---|---|
| seq_ibc_flag | u(2) |

or

| | |
|---|---|
| seq_ibc_flag | ue(v) |

seq_ibc_flag is a sequence header block copy mode flag; and

indicates a mode type of a block copy intra prediction mode, a value being ‘0’ indicates that the IBC is not to be used, a value being greater than ‘0’ indicates that the IBC may be used, and indicates whether the IBCPF is allowed. A value of SeqIbcFlag is equal to a value of seq_ibc_flag. If seq_ibc_flag does not exist in the bit stream, the value of SeqIbcFlag is 0.

S620: Determine whether the value of seq_ibc_flag is 2. If the value is not 2, the use of the IBC mode is not allowed for the current sequence, or the use of the IBC mode is allowed but the use of the IBCPF mode is not allowed for the current sequence. In other words, a target block satisfying the foregoing condition in this application does not exist in the current sequence. Therefore, the sequence regarding the IBC or the IBCPF (for example, a frame-level flag or a slice-level flag) does not need to be further parsed, and S630 of determining that the current sequence does not include the target block is directly performed, thereby reducing time consumption of decoding and improving decoding efficiency.

S620: Determine whether the value of seq_ibc_flag is 2. If the value is 2, the use of the IBC mode and the IBCPF mode is allowed for the current sequence. In other words, the target block satisfying the foregoing condition in this application exists in the current sequence. Therefore, the frame in which the foregoing target block exists needs to be further determined. Therefore, an operation such as S660 of parsing a frame-level flag to determine the foregoing target block based on the flag of the next-level syntactic structure is performed. For a specific implementation of S660 in this embodiment, reference is made to Embodiment 2 of the method P600. Certainly, the implementation is not limited to Embodiment 2 of the method P600, and may also be another embodiment in which determining is performed based on a frame-level flag.

Embodiment 2 of the method P600: The foregoing first-level syntactic structure is frame-level. It is assumed that the foregoing first IBC flag may be represented as pic_ibc_flag. Semantic information respectively represented by different values of pic_ibc_flag is shown in Table 2.

TABLE 2

| pic_ibc_flag | Semantics |
|---|---|
| 0 | Use of the IBC mode is not allowed |
| 1 | Use of the IBC mode is allowed, but use of the |
| | IBCPF mode is not allowed |
| 2 | Use of the IBC mode and the IBCPF mode is allowed |

A syntactic structure of Table 2 is:

| | |
|---|---|
| pic_ibc_flag | u(2) |

or

| | |
|---|---|
| pic_ibc_flag | ue(v) |

pic_ibc_flag is a picture header block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of PicIbcFlag is equal to a value of pic_ibc_flag. If pic_ibc_flag does not exist in a bit stream, the value of PicIbcFlag is 0.

S620: Determine whether the value of pic_ibc_flag is 2. If the value is not 2, the use of the IBC mode is allowed for the current frame, or the use of the IBC mode is allowed but the use of the IBCPF mode is not allowed for the current frame. In other words, a target block satisfying the foregoing condition in this application does not exist in the current frame. Therefore, the frame regarding the IBC or the IBCPF (for example, a slice-level flag or a block-level flag) does not need to be further parsed, and S630 of determining that the current frame does not include the target block is directly performed, thereby reducing time consumption of decoding and improving decoding efficiency.

S620: Determine whether the value of pic_ibc_flag is 2. If the value is 2, the use of the IBC mode and the IBCPF mode is allowed for the current frame. In other words, the target block satisfying the foregoing condition in this application exists in the current frame. Therefore, the slice in which the foregoing target block exists needs to be further determined. Therefore, an operation such as S660 of parsing a slice-level flag to determine the foregoing target block based on the flag of the next-level syntactic structure is performed. For a specific implementation of S660 in this embodiment, reference is made to Embodiment 3 of the method P600. Certainly, the implementation is not limited to Embodiment 3 of the method P600, and may also be another embodiment in which determining is performed based on a slice-level flag.

Embodiment 3 of the method P600: The foregoing first-level syntactic structure is slice-level. It is assumed that the foregoing first IBC flag may be represented as slice_ibc_flag. Semantic information respectively represented by different values of slice_ibc_flag is shown in Table 3.

TABLE 3

| slice_ibc_flag | Semantics |
|---|---|
| 0 | Use of the IBC mode is not allowed |
| 1 | Use of the IBC mode is allowed, but use of the |
| | IBCPF mode is not allowed |
| 2 | Use of the IBC mode and the IBCPF mode is allowed |

A syntactic structure of Table 3 is:

| | |
|---|---|
| slice_ibc_flag | u(2) |

or

| | |
|---|---|
| slice_ibc_flag | ue(v) |

slice_ibc_flag is a slice header block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of SliceIbcFlag is equal to a value of slice_ibc_flag. If slice_ibc_flag does not exist in the bit stream, the value of SliceIbcFlag is 0.

S620: Determine whether the value of slice_ibc_flag is 2. If the value is not 2, the use of the IBC mode is allowed for the current slice, or the use of the IBC mode is allowed but the use of the IBCPF mode is not allowed for the current slice. In other words, a target block satisfying the foregoing condition in this application does not exist in the current slice. Therefore, the slice regarding the IBC or the IBCPF (for example, a block-level flag) does not need to be further parsed, and S630 of determining that the current slice does not include the target block is directly performed, thereby reducing time consumption of decoding and improving decoding efficiency.

S620: Determine whether the value of slice_ibc_flag is 2. If the value is 2, the use of the IBC mode and the IBCPF mode is allowed for the current slice. In other words, the target block satisfying the foregoing condition in this application exists in the current slice. Therefore, the block belonging to the foregoing target block needs to be further determined. Therefore, an operation such as S660 of parsing a block-level flag to determine the foregoing target block based on the flag of the next-level syntactic structure is performed. For a specific implementation of S660 in this embodiment, reference is made to Embodiment 4 of the method P600. Certainly, the implementation is not limited to Embodiment 4 of the method P600, and may also be another embodiment in which determining is performed based on a block-level flag.

Embodiment 4 of the method P600: The foregoing first-level syntactic structure is block-level. It is assumed that the foregoing first IBC flag may be represented as cu_ibc_flag. Semantic information respectively represented by different values of cu_ibc_flag is shown in Table 4.

TABLE 4

| cu_ibc_flag | Semantics |
|---|---|
| 0 | Use of the IBC mode is not allowed |
| 1 | Use of the IBC mode is allowed, but use of |
| | the IBCPF mode is not allowed |
| 2 | Use of the IBC mode and the IBCPF mode is allowed |

A syntactic structure of Table 4 is:

| | |
|---|---|
| cu_ibc_flag | ae(v) |

cu_ibc_flag is a block-level block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of CuIbcFlag is equal to a value of cu_ibc_flag. If cu_ibc_flag does not exist in the bit stream, the value of CuIbcFlag is 0.

S620: Determine whether the value of cu_ibc_flag is 2. If the value is not 2, the use of the IBC mode is not allowed for the current block, or the use of the IBC mode is allowed but the use of the IBCPF mode is not allowed for the current block. In other words, the target block satisfying the foregoing condition in this application does not exist in the current block. Therefore, it is determined that the current block is not the target block.

S620: Determine whether the value of cu_ibc_flag is 2. If the value is 2, the use of the IBC mode and the IBCPF mode is allowed for the current block. In other words, the target block satisfying the foregoing condition in this application belongs to the current block. Therefore, S650 of determining the current block as the target block is performed.

In the foregoing embodiment of the method P600, the foregoing target block is identified by using a flag of each level of an encoded bit stream, which helps reduce a decoding duration and improve decoding efficiency and performance.

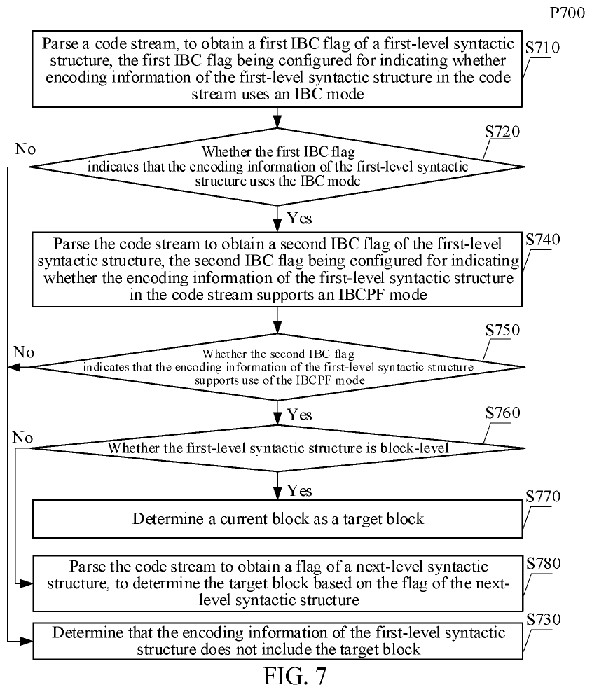

FIG. 7 is a schematic flowchart of a method P700 for determining a target block according to another embodiment of this application. The embodiment shown in the figure may be used as another specific implementation of S510. Referring to FIG. 7, the embodiment shown in the figure includes S710-S780.

S710: Parse the code stream, to obtain a first IBC flag of a first-level syntactic structure, the first IBC flag being configured for indicating whether encoding information of the first-level syntactic structure in the code stream uses an IBC mode.

S720: Determine whether the first IBC flag indicates that the encoding information of the first-level syntactic structure uses the IBC mode.

When the first IBC flag indicates that the encoding information of the first-level syntactic structure does not use the IBC mode, S730 of determining that the encoding information of the first-level syntactic structure does not include the target block is performed.

When the first IBC flag indicates that the encoding information of the first-level syntactic structure uses the IBC mode, the second IBC flag being configured for indicating whether the encoding information of the first-level syntactic structure in the code stream supports an IBCPF mode, S740 of parsing the code stream, to obtain a second IBC flag of the first-level syntactic structure is performed.

S750: Determine whether the second IBC flag indicates that the encoding information of the first-level syntactic structure supports use of the IBCPF mode.

When the second IBC flag indicates that the encoding information of the first-level syntactic structure does not support use of the IBCPF mode, S730 of determining that the encoding information of the first-level syntactic structure does not include the target block is performed.

When the second IBC flag indicates that the encoding information of the first-level syntactic structure supports the use of the IBC mode and supports the IBCPF mode, S760 of determining whether the first-level syntactic structure is block-level is performed.

When the first-level syntactic structure is block-level, S770 of determining a current block as the target block is performed.

When the first-level syntactic structure is not block-level, S780 of parsing the code stream to obtain a flag of a next-level syntactic structure, to determine the target block based on the flag of the next-level syntactic structure is performed.

Embodiment 1 of the method P700: The foregoing first-level syntactic structure is sequence-level. It is assumed that the foregoing first IBC flag may be represented as seq_ibc_flag, and the foregoing second IBC flag may be represented as seq_ibc_pf_flag. Semantic information respectively represented by different values of seq_ibc_flag and seq_ibc_pf_flag is shown in Table 5.

TABLE 5

| seq_ibc_flag | seq_ibc_pf_flag | Semantics |
|---|---|---|
| 0 | X | Use of the IBC mode is not allowed |
| 1 | 0 | Use of the IBC mode is allowed, but |
| | | use of the IBCPF mode is not |
| | | allowed |
| 1 | 1 | Use of the IBC mode and the IBCPF |
| | | mode is allowed |

A syntactic structure of Table 5 is as follows:

| | |
|---|---|
| seq_{—}ibc_{—}flag | u(1) |
| if (SeqIbcFlag) { | |
| seq_{—}ibc_{—}pf_{—}flag | u(1) |
| } | |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.
seq_ibc_pf_flag is a sequence header block copy intra prediction filtering mode flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

When the value of seq_ibc_flag is 0, the current sequence does not use the IBC mode for coding prediction. Therefore, decoding does not need to be performed on seq_ibc_pf_flag, thereby reducing time consumption of decoding and improving decoding efficiency. In other words, when the value of seq_ibc_flag is 0, no matter which value of seq_ibc_pf_flag is, the foregoing target block does not exist in the sequence. Referring to Table 5, when the value of seq_ibc_flag is 0, the value of seq_ibc_pf_flag is represented as “X”. In this case, S730 of determine that the current sequence does not include the target block is directly performed, thereby reducing time consumption of decoding and improving decoding efficiency.

When the value of seq_ibc_flag is 1, the use of the IBC mode is allowed for the current sequence for coding prediction, and the value of seq_ibc_pf_flag needs to be further decoded (namely, S740 is performed). The following two cases exist.

Case 1: The value of seq_ibc_flag is 1 and the value of seq_ibc_pf_flag is 0, indicating that although the use of the IBC mode is allowed for the current sequence, the IBCPF mode is not supported. In other words, a target block satisfying the foregoing condition in this application does not exist in the current sequence. Therefore, the sequence regarding the IBC or the IBCPF (for example, a frame-level flag or a slice-level flag) does not need to be further parsed, and S730 of determining that the current sequence does not include the target block is directly performed, thereby reducing time consumption of decoding and improving decoding efficiency.

Case 2: The value of seq_ibc_flag is 1 and the value of seq_ibc_pf_flag is 1, indicating that the use the IBC mode and the IBCPF mode is allowed for the current sequence. In other words, the target block satisfying the foregoing condition in this application exists in the current sequence. Therefore, the frame in which the foregoing target block exists needs to be further determined. Therefore, an operation such as S780 of parsing a frame-level flag to determine the foregoing target block based on the flag of the next-level syntactic structure is performed. For a specific implementation of S780 in this embodiment, reference is made to Embodiment 2 of the method P700. Certainly, the implementation is not limited to Embodiment 2 of the method P700, and may also be another embodiment in which determining is performed based on a frame-level flag.

Embodiment 2 of the method P700: The foregoing first-level syntactic structure is sequence-level. It is assumed that the foregoing first IBC flag may be represented as pic_ibc_flag, and the foregoing second IBC flag may be represented as pic_ibc_pf_flag. Semantic information respectively represented by different values pic_ibc_flag and pic_ibc_pf_flag is shown in Table 6.

TABLE 6

| pic_ibc_flag | pic_ibc_pf_flag | Semantics |
|---|---|---|
| 0 | X | Use of the IBC mode is not allowed |
| 1 | 0 | Use of the IBC mode is allowed, but |
| | | use of the IBCPF mode is not |
| | | allowed |
| 1 | 1 | Use of the IBC mode and the IBCPF |
| | | mode is allowed |

A syntactic structure of Table 6 is as follows:

| | |
|---|---|
| pic_{—}ibc_{—}flag | u(1) |
| if (PicIbcFlag) { | |
| pic_{—}ibc_{—}pf_{—}flag | u(1) |
| } | |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.
pic_ibc_pf_flag is a picture header block copy intra prediction filtering mode flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

When the value of pic_ibc_flag is 0, the current frame does not use the IBC mode for coding prediction. Therefore, decoding does not need to be performed on pic_ibc_pf_flag, thereby reducing time consumption of decoding and improving decoding efficiency. In other words, when the value of pic_ibc_flag is 0, no matter which value of pic_ibc_pf_flag is, the foregoing target block does not exist in the frame. Referring to Table 6, when the value of pic_ibc_flag is 0, the value of pic_ibc_pf_flag is represented as “X”. In this case, S730 of determining that the current frame does not include the target block is directly performed, thereby reducing time consumption of decoding and improving decoding efficiency.

When the value of pic_ibc_flag is 1, the use of the IBC mode is allowed for the current frame for coding prediction, and the value of pic_ibc_pf_flag needs to be further decoded (namely, S740 is performed). The following two cases exist.

Case 1: The value of pic_ibc_flag is 1 and the value of pic_ibc_pf_flag is 0, indicating that although the use of the IBC mode is allowed for the current frame, the IBCPF mode is not supported. In other words, a target block satisfying the foregoing condition in this application does not exist in the current frame. Therefore, the frame regarding the IBC or the IBCPF (for example, a slice-level flag or a block-level flag) does not need to be further parsed, and S730 of determining that the current frame does not include the target block is directly performed, thereby reducing time consumption of decoding and improving decoding efficiency.

Case 2: The value of pic_ibc_flag is 1 and the value of pic_ibc_pf_flag is 1, indicating that the use the IBC mode and the IBCPF mode is allowed for the current frame. In other words, the target block satisfying the foregoing condition in this application exists in the current frame. Therefore, the slice in which the foregoing target block exists needs to be further determined. Therefore, an operation such as S780 of parsing a slice-level flag to determine the foregoing target block based on the flag of the next-level syntactic structure is performed. For a specific implementation of S780 in this embodiment, reference is made to Embodiment 3 of the method P700. Certainly, the implementation is not limited to Embodiment 3 of the method P700, and may also be another embodiment in which determining is performed based on a slice-level flag.

Embodiment 3 of the method P700: The foregoing first-level syntactic structure is slice-level. It is assumed that the foregoing first IBC flag may be represented as slice_ibc_flag, and the foregoing second IBC flag may be represented as slice_ibc_pf_flag. Semantic information respectively represented by different slice_ibc_flag and slice_ibc_pf_flag is shown in Table 7.

TABLE 7

| slice_ibc_{—} | slice_ibc_{—} | |
|---|---|---|
| flag | pf_flag | Semantics |
| 0 | X | Use of the IBC mode is not allowed |
| 1 | 0 | Use of the IBC mode is allowed, but use of |
| | | the IBCPF mode is not allowed |
| 1 | 1 | Use of the IBC mode and the IBCPF mode is |
| | | allowed |

A syntactic structure of Table 7 is as follows:

| | |
|---|---|
| slice_{—}ibc_{—}flag | u(1) |
| if (SliceIbcFlag) { | |
| slice_{—}ibc_{—}pf_{—}flag | u(1) |
| } | |

slice_ibc_flag is a slice header block copy intra prediction flag; and
is a binary variable. A value of ‘1’ indicates that the IBC mode may be used, and a value of ‘0’ indicates that the IBC mode is not to be used. A value of SliceIbcFlag is equal to a value of slice_ibc_flag. If slice_ibc_flag does not exist in the bit stream, the value of SliceIbcFlag is 0.
slice_ibc_pf_flag is a slice header block copy intra prediction filtering mode flag; and
is a binary variable. A value of ‘1’ indicates that the IBCPF mode may be used, and a value of ‘0’ indicates that the IBCPF mode is not to be used. A value of SliceIbcPfFlag is equal to a value of slice_ibc_pf_flag. If slice_ibc_pf_flag does not exist in the bit stream, the value of SliceIbcPfFlag is 0.

When the value of slice_ibc_flag is 0, the current slice does not use the IBC mode for coding prediction. Therefore, decoding does not need to be performed on slice_ibc_pf_flag, thereby reducing time consumption of decoding and improving decoding efficiency. In other words, when the value of slice_ibc_flag is 0, no matter which value of slice_ibc_pf_flag is, the foregoing target block does not exist in the slice. Referring to Table 7, when the value of slice_ibc_flag is 0, the value of slice_ibc_pf_flag is represented as “X”. In this case, S730 of determining that the current slice does not include the target block is directly performed, thereby reducing time consumption of decoding and improving decoding efficiency.

When the value of slice_ibc_flag is 1, the use of the IBC mode is allowed for the current slice for coding prediction, and the value of slice_ibc_pf_flag needs to be further decoded (namely, S740 is performed). The following two cases exist.

Case 1: The value of slice_ibc_flag is 1 and the value of slice_ibc_pf_flag is 0, indicating that although the use of the IBC mode is allowed for the current slice, the IBCPF mode is not supported. In other words, a target block satisfying the foregoing condition in this application does not exist in the current slice. Therefore, the slice regarding the IBC or the IBCPF (for example, a block-level flag) does not need to be further parsed, and S730 of determining that the current slice does not include the target block is directly performed, thereby reducing time consumption of decoding and improving decoding efficiency.

Case 2: The value of slice_ibc_flag is 1 and the value of slice_ibc_pf_flag is 1, indicating that the use of the IBC mode and the IBCPF mode is allowed for the current slice. In other words, the target block satisfying the foregoing condition in this application exists in the current slice. Therefore, the block belonging to the foregoing target block needs to be further determined. Therefore, an operation such as S780 of parsing a block-level flag to determine the foregoing target block based on the flag of the next-level syntactic structure is performed. For a specific implementation of S780 in this embodiment, reference is made to Embodiment 4 of the method P700. Certainly, the implementation is not limited to Embodiment 4 of the method P700, and may also be another embodiment in which determining is performed based on a block-level flag.

Embodiment 4 of the method P700: The foregoing first-level syntactic structure is block-level. It is assumed that the foregoing first IBC flag may be represented as cu_ibc_flag, and the foregoing second IBC flag may be represented as cu_ibc_pf_flag. Semantic information respectively represented by different cu_ibc_flag and cu_ibc_pf_flag is shown in Table 8.

TABLE 8

| cu_ibc_{—} | cu_ibc_{—} | |
|---|---|---|
| flag | pf_flag | Semantics |
| 0 | X | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

A syntactic structure of Table 8 is as follows:

| | |
|---|---|
| cu_{—}ibc_{—}flag | ae(v) |
| if (CuIbcPfFlag) { | |
| cu_{—}ibc_{—}pf_{—}flag | ae(v) |
| } | |

cu_ibc_flag is a block-level block copy intra prediction flag; and
is a binary variable. A value of ‘1’ indicates that the IBC mode may be used, and a value of ‘0’ indicates that the IBC mode is not to be used. A value of CuIbcFlag is equal to a value of cu_ibc_flag. If cu_ibc_flag does not exist in the bit stream, the value of CuIbcFlag is 0.
cu_ibc_pf_flag is a block-level block copy intra prediction filtering mode flag; and
is a binary variable. A value of ‘1’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.

When the value of cu_ibc_flag is 0, the current block does not use the IBC mode for coding prediction. Therefore, decoding does not need to be performed on cu_ibc_pf_flag, thereby reducing time consumption of decoding and improving decoding efficiency. In other words, when the value of cu_ibc_flag is 0, no matter which value of cu_ibc_pf_flag is, the foregoing target block does not exist in the block. Referring to Table 8, when the value of cu_ibc_flag is 0, the value of cu_ibc_pf_flag is represented as “X”. In this case, S730 of determining that the current block does not belong to the target block is directly performed, thereby reducing time consumption of decoding and improving decoding efficiency.

When the value of cu_ibc_flag is 1, the use of the IBC mode is allowed for the current block for coding prediction, and the value of cu_ibc_pf_flag needs to be further decoded (namely, S740 is performed). The following two cases exist.

Case 1: The value of cu_ibc_flag is 1 and the value of cu_ibc_pf_flag is 0, indicating that although the use of the IBC mode is allowed for the current block, the IBCPF mode is not supported. In other words, the current block does not satisfy the target block of the foregoing condition in this application. In this case, S730 of determining that the current block does not belong to the target block is performed.

Case 2: The value of cu_ibc_flag is 1 and the value of cu_ibc_pf_flag is 1, indicating that the use of the IBC mode and the IBCPF mode is allowed for the current block. In other words, the current block satisfies the target block of the foregoing condition in this application. In this case, S770 of determining the current block as the foregoing target block is performed.

In the foregoing embodiment of the method P700, the target block is identified through two flags of each level of an encoded bit stream, and the second IBC flag depends on a value of the first IBC flag of the same level. Specifically, when it is determined that the current level does not support the IBC mode through the value of the first IBC flag of the same level, the second IBC flag of the current level does not need to be decoded, thereby helping reduce a decoding duration and improving decoding efficiency and performance.

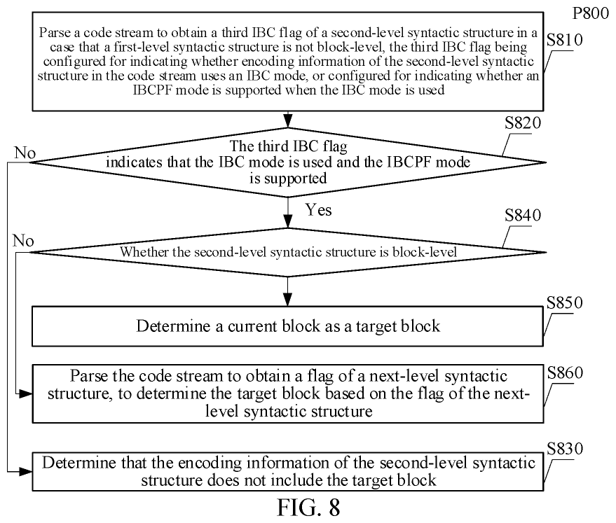

FIG. 8 is a schematic flowchart of a method P800 for determining a target block according to yet another embodiment of this application. The embodiment shown in the figure may be used as yet another specific implementation of S510. Specifically, the embodiment shown in FIG. 8 may be used as a specific implementation of S660 in FIG. 6, or may be used as a specific implementation of S780 in FIG. 7. Referring to FIG. 8, the embodiment shown in the figure includes S810-S860.

S810: Parse the code stream to obtain a third IBC flag of a second-level syntactic structure when the first-level syntactic structure is not block-level, the third IBC flag being configured for indicating whether encoding information of the second-level syntactic structure in the code stream uses the IBC mode, or configured for indicating whether the IBCPF mode is supported when the IBC mode is used.

As described above, syntax levels of the encoded bit stream include sequence-level, frame-level, slice-level, block-level, and the like.

In this embodiment of this application, the foregoing second-level syntactic structure may be frame-level, slice-level, or block-level. Specifically, when the foregoing first-level syntactic structure is sequence-level, the second-level syntactic structure is frame-level. Alternatively, when the foregoing first-level syntactic structure is frame-level or sequence-level, the second-level syntactic structure is slice-level. Alternatively, when the first-level syntactic structure is slice-level, frame-level, or sequence-level, the second-level syntactic structure is block-level.

S820: Determine that the third IBC flag indicates that the encoding information of the second-level syntactic structure uses the IBC mode and supports the IBCPF mode.

When the third IBC flag indicates that the encoding information of the second-level syntactic structure does not use the IBC mode, or when the third IBC flag indicates that the encoding information of the second-level syntactic structure uses the IBC mode and does not support the IBCPF mode, S830 of determining that the encoding information of the second-level syntactic structure does not include the target block is performed.

When the third IBC flag indicates that the encoding information of the second-level syntactic structure uses the IBC mode and supports the IBCPF mode, S840 of determining whether the second-level syntactic structure is block-level is performed.

When the second-level syntactic structure is block-level, S850 of determining a current block as the target block is performed.

When the second-level syntactic structure is not block-level, S860 of parsing the code stream to obtain a flag of a next-level syntactic structure, to determine the target block based on the flag of the next-level syntactic structure is performed.

In the embodiment shown in FIG. 6 or FIG. 7, when the first-level syntactic structure is block-level, whether the current block is the target block may be directly determined, and the embodiment shown in FIG. 8 does not need to be performed. In the embodiment shown in FIG. 6 or FIG. 7, when the first-level syntactic structure is not block-level, whether the current block is the target block cannot be directly determined. Therefore, the embodiment shown in FIG. 8 needs to be performed.

A specific implementation of the embodiment shown in FIG. 8 is similar to a specific implementation of the embodiment shown in FIG. 6. A difference lies in that the embodiment shown in FIG. 6 is applicable to an embodiment in which the target block is determined based on a sequence-level flag, and the embodiment shown in FIG. 8 is applicable to an embodiment in which the target block is determined based on a frame-level flag, a slice-level flag, a block-level flag, or the like other than a sequence-level flag.

In other words, in the embodiment provided by the method P800, when whether the target block exists cannot be determined based on the flag of the first-level syntactic structure, the target block is determined based on a flag of a next-level syntactic structure and the embodiment provided by the method P800. Specifically, the foregoing target block is identified by using a flag of each level of an encoded bit stream, which helps reduce a decoding duration and improve decoding efficiency and performance.

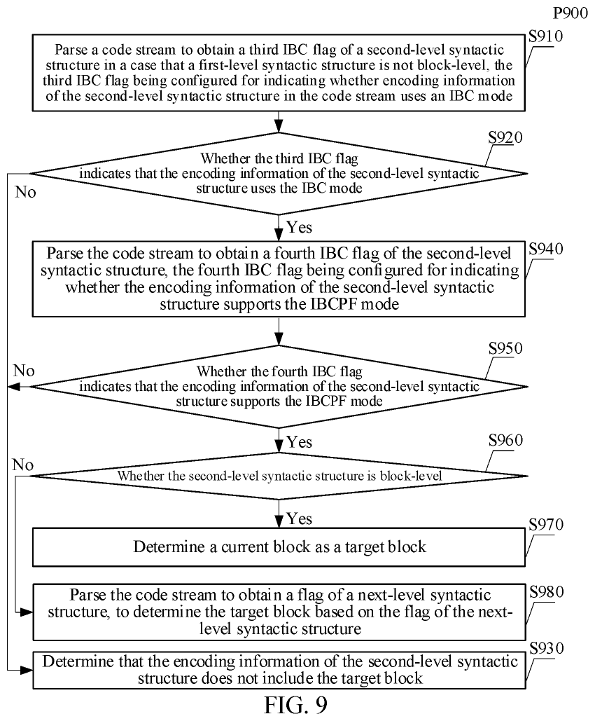

FIG. 9 is a schematic flowchart of a method P900 for determining a target block according to still another embodiment of this application. The embodiment shown in the figure may be used as still another specific implementation of S510. Specifically, the embodiment shown in FIG. 9 may be used as a specific implementation of S660 in FIG. 6, or may be used as a specific implementation of S780 in FIG. 7. Referring to FIG. 9, the embodiment shown in the figure includes S910-S980.

S910: Parse the code stream to obtain a third IBC flag of a second-level syntactic structure when the first-level syntactic structure is not block-level, the third IBC flag being configured for indicating whether encoding information of the second-level syntactic structure in the code stream uses the IBC mode.

As described above, syntax levels of the encoded bit stream include sequence-level, frame-level, slice-level, block-level, and the like.

In this embodiment of this application, the foregoing second-level syntactic structure may be frame-level, slice-level, or block-level. Specifically, when the foregoing first-level syntactic structure is sequence-level, the second-level syntactic structure is frame-level. Alternatively, when the foregoing first-level syntactic structure is frame-level or sequence-level, the second-level syntactic structure is slice-level. Alternatively, when the first-level syntactic structure is slice-level, frame-level, or sequence-level, the second-level syntactic structure is block-level.

S920: Determine whether the third IBC flag indicates that the encoding information of the second-level syntactic structure uses the IBC mode.

When the fourth IBC flag indicates that the encoding information of the second-level syntactic structure does not support the use of the IBCPF mode, S930 of determining that the encoding information of the second-level syntactic structure does not include the target block is performed.

When the third IBC flag indicates that the encoding information of the second-level syntactic structure uses the IBC mode, the fourth IBC flag being configured for indicating whether the encoding information of the second-level syntactic structure supports the IBCPF mode, S940 of parsing the code stream to obtain a fourth IBC flag of the second-level syntactic structure is performed.

S950: Determine whether the fourth IBC flag indicates that the encoding information of the second-level syntactic structure supports the IBCPF mode.

When the fourth IBC flag indicates that the encoding information of the second-level syntactic structure supports the IBCPF mode, S960 of determining whether the second-level syntactic structure is block-level is performed.

When the second-level syntactic structure is block-level, S970 of determining a current block as the target block is performed.

When the second-level syntactic structure is not block-level, S980 of parsing the code stream to obtain a flag of a next-level syntactic structure, to determine the target block based on the flag of the next-level syntactic structure is performed.

In the embodiment shown in FIG. 6 or FIG. 7, when the first-level syntactic structure is block-level, whether the current block is the target block may be directly determined, and the embodiment shown in FIG. 9 does not need to be performed. In the embodiment shown in FIG. 6 or FIG. 7, when the first-level syntactic structure is not block-level, whether the current block is the target block cannot be directly determined. Therefore, the embodiment shown in FIG. 9 needs to be performed.

A specific implementation of the embodiment shown in FIG. 9 is similar to a specific implementation of the embodiment shown in FIG. 7. A difference lies in that the embodiment shown in FIG. 7 is applicable to an embodiment in which the target block is determined based on a sequence-level flag, and the embodiment shown in FIG. 9 is applicable to an embodiment in which the target block is determined based on a frame-level flag, a slice-level flag, a block-level flag, or the like other than a sequence-level flag.

In other words, in the embodiment provided by the method P900, when whether the target block exists cannot be determined based on the flag of the first-level syntactic structure, the target block is determined based on a flag of a next-level syntactic structure and the embodiment provided by the method P900. Specifically, the foregoing target block is identified through two flags of the same level of an encoded bit stream, and the second IBC flag depends on a value of the first IBC flag of the same level. In addition, when it is determined that the current level does not support the IBC mode through the value of the first IBC flag of the same level, the second IBC flag of the current level does not need to be decoded, thereby helping reduce a decoding duration and improving decoding efficiency and performance.

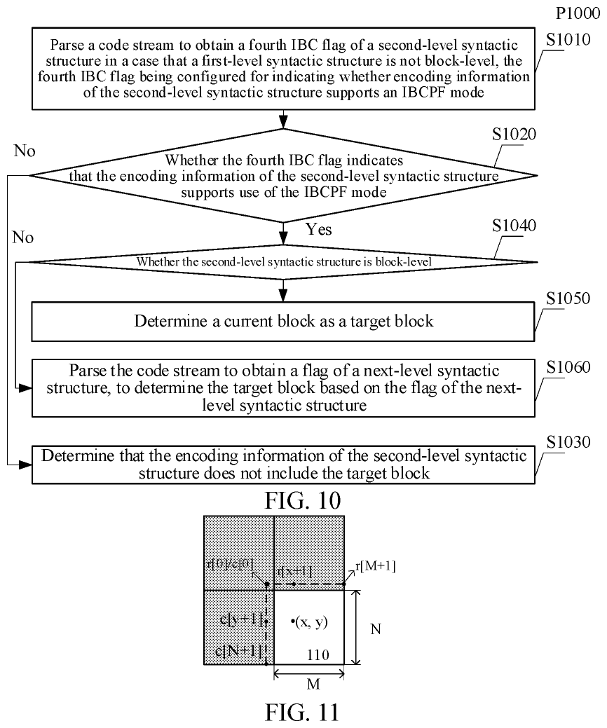

FIG. 10 is a schematic flowchart of a method P1000 for determining a target block according to an embodiment of this application. The embodiment shown in the figure may be used as a specific implementation of S510. Specifically, the embodiment shown in FIG. 10 may be used as a specific implementation of S660 in FIG. 6, or may be used as a specific implementation of S780 in FIG. 7. Referring to FIG. 10, the embodiment shown in the figure includes S1010-S1050. 1010: Parse the code stream to obtain a fourth IBC flag of the second-level syntactic structure when the first-level syntactic structure is not block-level, the fourth IBC flag being configured for indicating whether the encoding information of the second-level syntactic structure supports the IBCPF mode.

1020: Determine whether the fourth IBC flag indicates that the encoding information of the second-level syntactic structure supports use of the IBCPF mode.

When the fourth IBC flag indicates that the encoding information of the second-level syntactic structure does not support the use of the IBC mode, 1030 of determining that the encoding information of the second-level syntactic structure does not include the target block is performed.

When the fourth IBC flag indicates that the encoding information of the second-level syntactic structure supports the IBCPF mode, 1040 of determining whether the second-level syntactic structure is block-level is performed.

When the second-level syntactic structure is block-level, 1050 of determining a current block as the target block is performed.

When the second-level syntactic structure is not block-level, 1060 of parsing the code stream to obtain a flag of a next-level syntactic structure, to determine the target block based on the flag of the next-level syntactic structure is performed.

In this embodiment, the foregoing target block cannot be directly determined based on only the fourth IBC flag. Whether the current block satisfies the condition of the target block needs to be jointly determined by depending on a flag of a previous-level syntactic structure.

Embodiment 1 of the method P1000: In this embodiment, the foregoing second-level syntactic structure is frame-level, and the foregoing first-level syntactic structure is sequence-level. Specifically, assuming that the foregoing fourth IBC flag is a frame-level fourth IBC flag pic_ibc_pf_flag, related information may be determined by depending on a sequence-level (the previous-level syntactic structure) flag.

Embodiment 1.1: As shown in Table 9, the frame-level fourth IBC flag pic_ibc_pf_flag may determine related information by depending on a sequence-level (the previous-level syntactic structure) flag seq_ibc_flag.

TABLE 9

| seq_ibc_{—} | pic_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 9, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In a picture header:

| | |
|---|---|
| if (SeqIbcFlag) { | |
| pic_{—}ibc_{—}pf_{—}flag | u(n) |
| } | |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of pic_ibc_pf_flag. If pic_ibc_pf_flag does not exist in the bit stream, the value of PicIbcFlag is 0.

When the value of seq_ibc_flag is 0, the current sequence does not use the IBC mode for coding prediction. Therefore, decoding does not need to be performed on the frame-level fourth IBC flag pic_ibc_pf_flag, thereby reducing time consumption of decoding and improving decoding efficiency. In other words, when the value of seq_ibc_flag is 0, no matter which value of pic_ibc_pf_flag is, the foregoing target block does not exist in the frame. Referring to Table 9, when the value of seq_ibc_flag is 0, the value of the fourth IBC flag pic_ibc_pf_flag is represented as “X”. In this case, S830 of determining that the current frame does not include the target block is directly performed, thereby reducing time consumption of decoding and improving decoding efficiency.

When the value of seq_ibc_flag is 1, the use of the IBC mode is allowed for the current sequence for coding prediction, and the value of the frame-level fourth IBC flag pic_ibc_pf_flag needs to be further decoded (namely, S840 is performed). The following two cases exist.

Case 1: The value of seq_ibc_flag is 1 and the value of the frame-level fourth IBC flag pic_ibc_pf_flag is 0, indicating that although the use of the IBC mode is allowed for the current sequence, the current frame does not support the IBCPF mode. In other words, a target block satisfying the foregoing condition in this application does not exist in the current frame. Therefore, the sequence regarding the IBC or the IBCPF (for example, a slice-level flag) does not need to be further parsed, and S830 of determining that the current frame does not include the target block is directly performed, thereby reducing time consumption of decoding and improving decoding efficiency.

Case 2: The value of seq_ibc_flag is 1 and the value of the frame-level fourth IBC flag pic_ibc_pf_flag is 1, indicating that the use of the IBC mode is allowed for the current sequence and the use of the IBCPF mode is allowed for the current frame. In other words, the target block satisfying the foregoing condition in this application exists in the current frame. Therefore, the frame in which the foregoing target block exists needs to be further determined. Therefore, an operation such as S860 of parsing a slice-level flag to determine the foregoing target block based on the flag of the next-level syntactic structure is performed.

Embodiment 1.2: As shown in Table 10, the frame-level fourth IBC flag pic_ibc_pf_flag may determine related information by depending on a sequence-level (the previous-level syntactic structure) flag seq_ibc_pf_flag.

TABLE 10

| seq_ibc_{—} | pic_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 10, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In a picture header:

| | |
|---|---|
| if (SeqIbcPfFlag) { | |
| pic_{—}ibc_{—}pf_{—}flag | u(n) |
| } | |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_fp_flag. If pic_ibc_pf_flag does not exist in the bit stream, the value of PicIbcPfFlag is 0.

When the value of seq_ibc_pf_flag is 0, the current sequence does not support the use of the IBCPF mode. Therefore, decoding does not need to be performed on the frame-level fourth IBC flag pic_ibc_pf_flag, thereby reducing time consumption of decoding and improving decoding efficiency. In other words, when the value of seq_ibc_pf_flag is 0, no matter which value of pic_ibc_pf_flag is, the foregoing target block does not exist in the frame. Referring to Table 9, when the value of seq_ibc_flag is 0, the value of the fourth IBC flag pic_ibc_pf_flag is represented as “X”. In this case, S830 of determining that the current frame does not include the target block is directly performed, thereby reducing time consumption of decoding and improving decoding efficiency.

When the value of seq_ibc_pf_flag is 1, the current sequence supports the use of the IBCPF mode for prediction filtering, and the value of the frame-level fourth IBC flag pic_ibc_pf_flag needs to be further decoded (namely, S840 is performed). The following two cases exist.

Case 1: The value of seq_ibc_pf_flag is 1 and the value of the frame-level fourth IBC flag pic_ibc_pf_flag is 0, indicating that although the current sequence supports the use of the IBCPF mode, the current frame does not support the IBCPF mode. In other words, a target block satisfying the foregoing condition in this application does not exist in the current frame. Therefore, the sequence regarding the IBC or the IBCPF (for example, a slice-level flag) does not need to be further parsed, and S830 of determining that the current frame does not include the target block is directly performed, thereby reducing time consumption of decoding and improving decoding efficiency.

Case 2: The value of seq_ibc_pf_flag is 1 and the value of the frame-level fourth IBC flag pic_ibc_pf_flag is 1, indicating that both the current sequence and the current frame support the IBCPF mode. In other words, the target block satisfying the foregoing condition in this application exists in the current frame. Therefore, the frame in which the foregoing target block exists needs to be further determined. Therefore, an operation such as S860 of parsing a slice-level flag to determine the foregoing target block based on the flag of the next-level syntactic structure is performed.

Embodiment 2 of the method P1000: The foregoing second-level syntactic structure is slice-level. As described above, in this embodiment, the foregoing first-level syntactic structure may be sequence-level or frame-level. An example in which the first-level syntactic structure is frame-level is used in Embodiment 2.1 and Embodiment 2.2. Specifically, when it cannot be excluded that the frame does not use the IBC mode or the IBCPF mode based on the frame-level flag, this embodiment is performed. It is assumed that the foregoing fourth IBC flag may be represented as slice_ibc_pf_flag. A slice-level fourth IBC flag slice_ibc_pf_flag may determine related information by depending on a frame-level (the previous-level syntactic structure) flag.

Embodiment 2.1: As shown in Table 11, the slice-level fourth IBC flag slice_ibc_pf_flag may determine related information by depending on a frame-level (the previous-level syntactic structure) flag pic_ibc_flag.

TABLE 11

| pic_ibc_{—} | slice_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 11, in a picture header:

| | |
|---|---|
| pic_ibc_flag | u(1) |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.

In a slice header:

| | |
|---|---|
| if (PicIbcFlag) { | |
| slice_{—}ibc_{—}pf_{—}flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of slice_ibc_pf_flag. If slice_ibc_pf_flag does not exist in the bit stream, the value of PicIbcFlag is 0.

When the value of pic_ibc_flag is 0, the current frame does not use the IBC mode for coding prediction. Therefore, decoding does not need to be performed on the slice-level fourth IBC flag slice_ibc_pf_flag, thereby reducing time consumption of decoding and improving decoding efficiency. In other words, when the value of pic_ibc_flag is 0, no matter which value of slice_ibc_pf_flag is, the foregoing target block does not exist in the slice. Referring to Table 11, when the value of pic_ibc_flag is 0, the value of the fourth IBC flag slice_ibc_pf_flag is represented as “X”. In this case, S830 of determining that the current slice does not include the target block is directly performed, thereby reducing time consumption of decoding and improving decoding efficiency.

When the value of pic_ibc_flag is 1, the use of the IBC mode is allowed for the current frame for coding prediction, and the value of the slice-level fourth IBC flag slice_ibc_pf_flag needs to be further decoded (namely, S840 is performed). The following two cases exist.

Case 1: The value of pic_ibc_flag is 1 and the value of the slice-level fourth IBC flag slice_ibc_pf_flag is 0, indicating that although the use of the IBC mode is allowed for the current frame, the current slice does not support the IBCPF mode. In other words, a target block satisfying the foregoing condition in this application does not exist in the current slice. Therefore, the frame regarding the IBC or the IBCPF (for example, a slice-level flag) does not need to be further parsed, and S830 of determining that the current slice does not include the target block is directly performed, thereby reducing time consumption of decoding and improving decoding efficiency.

Case 2: The value of pic_ibc_flag is 1 and the value of the slice-level fourth IBC flag slice_ibc_pf_flag is 1, indicating that the use the IBC mode is allowed for the current frame and the use of the IBCPF mode is allowed for the current slice. In other words, the target block satisfying the foregoing condition in this application exists in the current slice. Therefore, the slice in which the foregoing target block exists needs to be further determined. Therefore, an operation such as S860 of parsing a slice-level flag to determine the foregoing target block based on the flag of the next-level syntactic structure is performed.

Embodiment 2.2: As shown in Table 12, the slice-level fourth IBC flag slice_ibc_pf_flag may determine related information by depending on a frame-level (the previous-level syntactic structure) flag pic_ibc_pf_flag.

TABLE 12

| pic_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 12, in a picture header:

| | |
|---|---|
| pic_ibc_pf_flag | u(1) |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

In a slice header:

| | |
|---|---|
| if (PicIbcPfFlag) { | |
| slice_{—}ibc_{—}pf_{—}flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of slice_ibc_pf_flag. If slice_ibc_pf_flag does not exist in the bit stream, the value of PicIbcPfFlag is 0.

When the value of pic_ibc_pf_flag is 0, the current frame does not support the use of the IBCPF mode. Therefore, decoding does not need to be performed on the slice-level fourth IBC flag slice_ibc_pf_flag, thereby reducing time consumption of decoding and improving decoding efficiency. In other words, when the value of pic_ibc_pf_flag is 0, no matter which value of slice_ibc_pf_flag is, the foregoing target block does not exist in the slice. Referring to Table 9, when the value of pic_ibc_flag is 0, the value of the fourth IBC flag slice_ibc_pf_flag is represented as “X”. In this case, S830 of determining that the current slice does not include the target block is directly performed, thereby reducing time consumption of decoding and improving decoding efficiency.

When the value of pic_ibc_pf_flag is 1, the current frame supports the use of the IBCPF mode for prediction filtering and the value of the slice-level fourth IBC flag slice_ibc_pf_flag needs to be further decoded (namely, S840 is performed). The following two cases exist.

Case 1: The value of pic_ibc_pf_flag is 1 and the value of the slice-level fourth IBC flag slice_ibc_pf_flag is 0, indicating that although the current frame supports the use of the IBCPF mode, the current slice does not support the IBCPF mode. In other words, a target block satisfying the foregoing condition in this application does not exist in the current slice. Therefore, the frame regarding the IBC or the IBCPF (for example, a slice-level flag) does not need to be further parsed, and S830 of determining that the current slice does not include the target block is directly performed, thereby reducing time consumption of decoding and improving decoding efficiency.

Case 2: The value of pic_ibc_pf_flag is 1 and the value of the slice-level fourth IBC flag slice_ibc_pf_flag is 1, indicating that both the current frame and the current slice support the IBCPF mode. In other words, the target block satisfying the foregoing condition in this application exists in the current slice. Therefore, the slice in which the foregoing target block exists needs to be further determined. Therefore, an operation such as S860 of parsing a slice-level flag to determine the foregoing target block based on the flag of the next-level syntactic structure is performed.

When the second-level syntactic structure is slice-level, in this embodiment, the foregoing first-level syntactic structure may also be sequence-level. An example in which the first-level syntactic structure is sequence-level is used in Embodiment 2.3 and Embodiment 2.4. A slice-level fourth IBC flag slice_ibc_pf_flag may determine related information by depending on a sequence-level (the previous-level syntactic structure) flag.

Embodiment 2.3: As shown in Table 13, the slice-level fourth IBC flag slice_ibc_pf_flag may determine related information by depending on a sequence-level (the previous-level syntactic structure) flag seq_ibc_flag.

TABLE 13

| seq_ibc_{—} | slice_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 13, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In a slice header:

| | |
|---|---|
| if (SeqIbcFlag) { | |
| slice_{—}ibc_{—}pf_{—}flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SeqIbcFlag is equal to a value of slice_ibc_pf_flag. If slice_ibc_pf_flag does not exist in the bit stream, the value of SeqIbcFlag is 0.

The embodiment provided by the method P1000 may be implemented with reference to various semantics shown in Table 13. For specific description, reference may further be made to the embodiment provided by the method P1000 that may be implemented in Embodiment 2.1 with reference to various semantics shown in Table 11.

Embodiment 2.4: As shown in Table 14, the slice-level fourth IBC flag slice_ibc_pf_flag may determine related information by depending on a sequence-level (the previous-level syntactic structure) flag seq_ibc_pf_flag.

TABLE 14

| seq_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 14, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In a slice header:

| | |
|---|---|
| if (SeqIbcPfFlag) { | |
| slice_{—}ibc_{—}pf_{—}flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of slice_ibc_pf_flag. If slice_ibc_pf_flag does not exist in a bit stream, the value of SeqIbcPfFlag is 0.

The embodiment provided by the method P1000 may be implemented with reference to various semantics shown in Table 14. For specific description, reference may further be made to the embodiment provided by the method P1000 that may be implemented in Embodiment 2.2 with reference to various semantics shown in Table 12.

Embodiment 3 of the method P1000: The foregoing second-level syntactic structure is block-level. As described above, in this embodiment, the foregoing first-level syntactic structure may be sequence-level, frame-level, or slice-level. An example in which the first-level syntactic structure is slice-level is used in Embodiment 3.1 and Embodiment 3.2. Specifically, when it cannot be excluded that the frame does not use the IBC mode or the IBCPF mode based on the slice-level flag, this embodiment is performed. It is assumed that the foregoing fourth IBC flag may be represented as cu_ibc_pf_flag. A block-level fourth IBC flag cu_ibc_pf_flag may determine related information by depending on a slice-level (the previous-level syntactic structure) flag.

Embodiment 3.1: As shown in Table 15, the block-level fourth IBC flag cu_ibc_pf_flag may determine related information by depending on a slice-level (the previous-level syntactic structure) flag slice_ibc_flag.

TABLE 15

| slice_ibc_{—} | cu_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 15, in a slice header:

| | |
|---|---|
| slice_ibc_flag | u(1) |

slice_ibc_flag is a slice header block copy intra prediction flag; and
is a binary variable. A value of ‘1’ indicates that the IBC mode may be used, and a value of ‘0’ indicates that the IBC mode is not to be used. A value of SliceIbcFlag is equal to a value of slice_ibc_flag. If slice_ibc_flag does not exist in the bit stream, the value of SliceIbcFlag is 0.

In an encoding block:

| | |
|---|---|
| if (SliceIbcFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SliceIbcFlag is equal to a value of cu_ibc_pf_flag. If cu_ibc_pf_flag does not exist in the bit stream, the value of SliceIbcFlag is 0.

The embodiment provided by the method P1000 may be implemented with reference to various semantics shown in Table 15. For specific description, reference may further be made to the embodiment provided by the method P1000 that may be implemented in Embodiment 2.1 with reference to various semantics shown in Table 11.

Embodiment 3.2: As shown in Table 16, the block-level fourth IBC flag cu_ibc_pf_flag may determine related information by depending on a slice-level (the previous-level syntactic structure) flag slice_ibc_pf_flag.

TABLE 16

| slice_ibc_{—} | cu_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 16, in a slice header:

| | |
|---|---|
| slice_ibc_pf_flag | u(1) |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SliceIbcPfFlag is equal to a value of slice_ibc_pf_flag. If slice_ibc_pf_flag does not exist in the bit stream, the value of SliceIbcPfFlag is 0.

In an encoding block:

| | |
|---|---|
| if (SliceIbcPfFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SliceIbcPfFlag is equal to a value of cu_ibc_pf_flag. If cu_ibc_pf_flag does not exist in a bit stream, the value of SliceIbcPfFlag is 0.

The embodiment provided by the method P1000 may be implemented with reference to various semantics shown in Table 16. For specific description, reference may further be made to the embodiment provided by the method P1000 that may be implemented in Embodiment 2.2 with reference to various semantics shown in Table 12.

When the second-level syntactic structure is block-level, in this embodiment, the foregoing first-level syntactic structure may also be frame-level. An example in which the first-level syntactic structure is frame-level is used in Embodiment 3.3 and Embodiment 3.4. A block-level fourth IBC flag cu_ibc_pf_flag may determine related information by depending on a frame-level (the previous-level syntactic structure) flag.

Embodiment 3.3: As shown in Table 17, the block-level fourth IBC flag cu_ibc_pf_flag may determine related information by depending on a frame-level (the previous-level syntactic structure) flag pic_ibc_flag.

TABLE 17

| pic_ibc_{—} | cu_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 17, in a picture header:

| | |
|---|---|
| pic_ibc_flag | u(1) |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.

In an encoding block:

| | |
|---|---|
| if (PicIbcFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of cu_ibc_pf_flag. If cu_ibc_pf_flag does not exist in the bit stream, the value of PicIbcFlag is 0.

The embodiment provided by the method P1000 may be implemented with reference to various semantics shown in Table 17. For specific description, reference may further be made to the embodiment provided by the method P1000 that may be implemented in Embodiment 2.3 with reference to various semantics shown in Table 13.

Embodiment 3.4: As shown in Table 18, the block-level fourth IBC flag cu_ibc_pf_flag may determine related information by depending on a frame-level (the previous-level syntactic structure) flag pic_ibc_pf_flag.

TABLE 18

| pic_ibc_{—} | cu_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 18, in a picture header:

| | |
|---|---|
| pic_ibc_pf_flag | u(1) |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

In an encoding block:

| | |
|---|---|
| if (PicIbcPfFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of cu_ibc_pf_flag. If cu_ibc_pf_flag does not exist in the bit stream, the value of PicIbcPfFlag is 0.

The embodiment provided by the method P1000 may be implemented with reference to various semantics shown in Table 14. For specific description, reference may further be made to the embodiment provided by the method P1000 that may be implemented in Embodiment 2.4 with reference to various semantics shown in Table 14.

When the second-level syntactic structure is block-level, in this embodiment, the foregoing first-level syntactic structure may also be sequence-level. An example in which the first-level syntactic structure is sequence-level is used in Embodiment 3.5 and Embodiment 3.6. A block-level fourth IBC flag cu_ibc_pf_flag may determine related information by depending on a sequence-level (the previous-level syntactic structure) flag.

Embodiment 3.5: As shown in Table 19, the block-level fourth IBC flag cu_ibc_pf_flag may determine related information by depending on a sequence-level (the previous-level syntactic structure) flag seq_ibc_flag.

TABLE 19

| seq_ibc_{—} | cu_ibc_{—} | |
|---|---|---|
| flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 19, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In an encoding block:

| | |
|---|---|
| if (SeqIbcFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SeqIbcFlag is equal to a value of cu_ibc_pf_flag. If cu_ibc_pf_flag does not exist in the bit stream, the value of SeqIbcFlag is 0.

The embodiment provided by the method P1000 may be implemented with reference to various semantics shown in Table 19. For specific description, reference may further be made to the embodiment provided by the method P1000 that may be implemented in Embodiment 2.3 with reference to various semantics shown in Table 13.

Embodiment 3.6: As shown in Table 20, the block-level fourth IBC flag cu_ibc_pf_flag may determine related information by depending on a sequence-level (the previous-level syntactic structure) flag seq_ibc_pf_flag.

TABLE 20

| seq_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but use of the |
| | | IBCPF mode is not allowed |
| 1 | 1 | Use of the IBC mode and the IBCPF mode is |
| | | allowed |

For a syntactic structure in Table 20, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In an encoding block:

| | |
|---|---|
| if (SeqIbcPfFlag) { | |
| cu_{—}ibc_{—}pf_{—}flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of cu_ibc_pf_flag. If cu_ibc_pf_flag does not exist in the bit stream, the value of SeqIbcPfFlag is 0.

The embodiment provided by the method P1000 may be implemented with reference to various semantics shown in Table 20. For specific description, reference may further be made to the embodiment provided by the method P1000 that may be implemented in Embodiment 2.4 with reference to various semantics shown in Table 14.

In the foregoing embodiment of the method P1000, when a lower level in an encoded bit stream includes a flag, the foregoing target block may be determined by depending on a flag above the level (a higher level). The target block is determined with reference to related flags of two levels, thereby providing a flexible determining manner, and helping reduce time consumption of encoding and decoding and improve encoding and decoding performance.

In still another implementation of S510:

S510-1: Parse the code stream to obtain a block-level fifth IBC flag, the fifth IBC flag being configured for indicating whether the current block supports an IBCPF mode, and different types of the supported IBCPF modes.

Not only the foregoing target block may be determined, but also a filtering mode of the target block may be further determined through the foregoing fifth IBC flag. Exemplarily, the foregoing fifth IBC flag may be represented as cu_ibc_pf_index. Table 21 shows related semantics of cu_ibc_pf_index.

TABLE 21

| cu_ibc_pf_flag | Semantics |
|---|---|
| 0 | The IBCPF mode is not used |
| 1 | An IBCPF mode 1 is used |
| 2 | An IBCPF mode 2 is used |

For a syntactic structure in Table 21, in a coding block:

| | |
|---|---|
| cu_ibc_pf_flag | ae(v) |

cu_ibc_pf_flag is a block-level block copy intra prediction filter flag; and
is a binary variable. A value being greater than ‘0’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.

S510-2: Determine that the current block is not the target block when the fifth IBC flag indicates that the current block does not support the IBCPF mode. Referring to Table 21, when the value of cu_ibc_pf_index is 0, the current block is determined not as the target block when the current block does not support the IBCPF mode.

S510-3: Determine the current block as the target block when the fifth IBC flag indicates that the current block supports any type of IBCPF mode. Referring to Table 21, when the value of cu_ibc_pf_index is 1 or 2, the current block supports the IBCPF mode, and the current block is determined as the target block.

In an exemplary embodiment, different IBCPF modes are obtained through decoding, which may also indicate that different filtering modes are used (the different filtering modes are described in detail in subsequent embodiments). For example, if the value of cu_ibc_pf_index obtained through decoding is 1, the value of cu_ibc_pf_index is 1. In this case, a filtering mode A may be used. If the value of cu_ibc_pf_index obtained through decoding is 2, the value of cu_ibc_pf_index is 2. In this case, a filtering mode B may be used.

In still another implementation of S510:

S510-1′: Parse a code stream to obtain a block-level fourth IBC flag and a block-level fifth IBC flag, the fourth IBC flag being configured for indicating whether the current block supports the IBCPF mode, and the fifth IBC flag being configured for indicating different types of the supported IBCPF modes.

Not only the foregoing target block may be determined, but also the filtering mode of the target block may be further determined with reference to the foregoing fourth IBC flag and fifth IBC flag. Exemplarily, the foregoing fourth IBC flag may be represented as cu_ibc_pf_flag, and the foregoing fifth IBC flag may be represented as cu_ibc_pf_index. Table 22 shows related semantics of cu_ibc_pf_flag and cu_ibc_pf_index.

TABLE 22

| cu_ibc_pf_flag | cu_ibc_pf_index | Semantics |
|---|---|---|
| 0 | x | The IBCPF mode is not used |
| 1 | 0 | An IBCPF mode 1 is used |
| 1 | 1 | An IBCPF mode 2 is used |

For a syntactic structure in Table 22, in a coding block:

| | |
|---|---|
| cu_{—}ibc_{—}pf_{—}flag | ae(v) |
| if (CuIbcPfFlag) { | |
| cu_{—}ibc_{—}pf_{—}index | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.
cu_ibc_pf_index is a block-level block copy intra prediction filter index; and
represents a used IBCPF mode. A value of CuIbcPfIndex is equal to a value of cu_ibc_pf_index. If cu_ibc_pf_index does not exist in the bit stream, the value of CuIbcPfIndex is 0.

S510-2′: Determine that the current block is not the target block when the fourth IBC flag indicates that the current block does not support the IBCPF mode. Referring to Table 22, when the value of cu_ibc_pf_flag is 0, to reduce time consumption of decoding, the fifth IBC flag may not be parsed when the current block does not support the IBCPF mode, and it is directly determined that the current block is not the target block.

S510-3′: Determine the current block as the target block when the fourth IBC flag indicates that the current block supports the IBCPF mode. In addition, the IBCPF mode may be determined based on indication information of the fifth IBC flag. Referring to Table 22, when the value of cu_ibc_pf_index is 0, the current block supports the IBCPF mode 1. When the value of cu_ibc_pf_index is 1, the current block supports the IBCPF mode 2. An applicable filtering mode may be determined based on the IBCPF mode supported by the target block.

In an exemplary embodiment, in addition to determining the foregoing flag through decoding, the foregoing flag may also be obtained in the following modes.

Embodiment 1: Block-level indication information (for example, cu_ibc_pf_flag and cu_ibc_pf_index) configured for indicating the IBCPF may be exported based on a template matching result. For example, an IBC predicted value is applied to a template and an IBCPF is applied to the template, costs (for example, SAD) of the template before and after the template is applied and the current block template are compared. If the costs of applying the IBCPF is less, the IBCPF is determined to be used. Otherwise, if the costs of applying the IBCPF becomes large, it is determined not to use the IBCPF.

Embodiment 2: Block-level indication information (for example, cu_ibc_pf_flag and cu_ibc_pf_index) configured for indicating the IBCPF may be exported based on an implicit coefficient (based on whether a transform coefficient satisfies a condition). Whether to use the IBCPF may be determined based on parity of an even number of transform coefficients. For example, the IBCPF is used for an odd number, and the IBCPF is not used for an even number.

In the embodiments of this application, in addition to the embodiment provided in FIG. 6 to FIG. 10 of how to explicitly determine the target block based on the foregoing flag, whether the current block is the foregoing target block may also be implicitly determined. Specifically,

S1: Parse the code stream to obtain target information, and determine whether the current block supports the IBCPF mode based on the target information. S2: Determine the current block as the target block when it is determined that the current block supports the IBCPF mode.

Embodiment 1: The foregoing target information is a type of a picture in which the current block is located.

Specifically, if it is determined that use of ibc_pf_flag is not allowed based on a picture type, syntax elements of a picture header and a lower level do not need to be decoded, to reduce time consumption of decoding. For example, use of the IBCPF mode is allowed only in an I-type picture. For a non-I-type picture, syntax elements related to an IBCPF in a block-level, a slice header, and a picture header thereof do not need to be decoded.

Embodiment 2: The foregoing target information is a color component of the current block.

For example, use of the IBCPF is only allowed for a luminance component, or the use of the IBCPF is only allowed for a chrominance component.

Use of the IBCPF is allowed when the current block is a specific color component. For example, the IBCPF is used only on a luminance component Y, or the IBCPF is used only on a chrominance component U or V, or the use of the IBCPF is allowed for luminance components Y, U, and V.

Embodiment 3: The foregoing target information is a size of the current block.

Specifically, the use of the IBCPF is allowed when a block size satisfies a condition. If the current block size does not satisfy the condition, a syntax element related to a block-level IBCPF does not need to be decoded. The block size includes one or more of a width, a height, or an area. The foregoing condition may be greater than a first threshold, greater than or equal to a second threshold, less than a third threshold, less than or equal to a fourth threshold, or the like. The foregoing plurality of thresholds are not limited, and may be determined based on an actual situation.

For example, use of the IBCPF is allowed only when the current block area (width×height) is greater than 64; or use of the IBCPF is allowed when the current block width is less than or equal to 64; or use of the IBCPF is allowed when the current block height is less than or equal to 64; or the like.

Embodiment 4: The foregoing target information is a type of a picture in which the current block is located.

In a non-specific picture type (for example, a non-I picture), one or more of the foregoing high-level syntax elements are decoded. For example, ibc_pf_flag needs to be decoded only in the non-I picture.

Embodiment 5: The foregoing target information is an adaptive block vector resolution (ABVR) of the current block.

Specifically, when the ABVR of the current block satisfies a specific condition, use of the IBCPF is allowed. If a value of the ABVR of the current block does not satisfy the condition, a syntax element related to a block-level IBCPF does not need to be decoded, to reduce time consumption of decoding.

Exemplarily, when the ABVR of the current block is a subset of an available ABVR list, use of the IBCPF is allowed. For example, if the available ABVR list is {1-pel, 4 pel}, the block-level IBCPF is decoded only when the current block vector resolution is 1-pel; or use of the IBCPF is allowed only when the current block vector resolution is 4-pel. For another example, if the available ABVR list is {1/4 pel, 1-pel, 4 pel}, use of the IBCPF is allowed only when the current block vector resolution is 1-pel; or use of the IBCPF is allowed only when the current block vector resolution is 1-pel or 4-pel, and the like.

Embodiment 6: The foregoing target information is a vector difference of the current block.

Exemplarily, when a current block vector difference (BVD) satisfies a condition, use of the IBCPF is allowed. If a value of the block vector difference of the current block does not satisfy the condition, a syntax element related to a block-level IBCPF does not need to be decoded, to improve decoding efficiency. For example, the foregoing condition is that an absolute value of a horizontal BVD and/or a vertical BVD of the current block satisfies a specific threshold. For example, the foregoing condition may be greater than a first threshold, greater than or equal to a second threshold, less than a third threshold, less than or equal to a fourth threshold, or the like. The foregoing plurality of thresholds are not limited, and may be determined based on an actual situation. For another example, use of the IBCPF is allowed only when the horizontal BVD and the vertical BVD of the current block are both equal to 0.

Embodiment 7: The foregoing target information is a vector index of the current block.

Exemplarily, when the vector index of the current block satisfies a condition, use of the IBCPF is allowed. If a prediction block vector index of the current block does not satisfy the condition, the syntax element related to a block-level IBCPF does not need to be decoded, to reduce time consumption of decoding. For example, the foregoing condition is that an absolute value of the block vector prediction index (bvp_idx) satisfies a specific threshold. For example, the foregoing condition may be greater than a first threshold, greater than or equal to a second threshold, less than a third threshold, less than or equal to a fourth threshold, or the like. The foregoing plurality of thresholds are not limited, and may be determined based on an actual situation.

Embodiment 8: The foregoing target information is an IBC tool corresponding to an IBC prediction mode of the current block.

In an exemplary embodiment, use of the IBCPF is allowed when the IBC tool level of the current block satisfies one or more of the following conditions.
1) The prediction block vector index is less than or equal to a first preset value. For example, the first preset value is 2;
2) The block vector difference is less than or equal to a second preset value. For example, the second preset value is 0; and
3) A precision of the ABVR satisfies a preset precision set. For example, the preset precision set is a precision less than or equal to 1 pel.

In another exemplary embodiment, when one or more IBC tools in Table 23 are not used, use of the IBCPF is allowed.

TABLE 23

| IBC tool | IBCPF |
|---|---|
| ABVR | 0 |
| SIBC, RRIBC, FIBC | 0 |
| IBC-PC, IBC-LIC | 0 |
| IBC-MBVD | 0 |
| IBC-TM, IBC-TM-AMVP, IBC-TM-MRG | 0 |
| IBC-BI-PRED | 0 |
| IBC-CHIP | 0 |
| IBC-GPM | 0 |

In Table 23, when the value of the IBCPF is 1, the use of the IBCPF is allowed for the current block with a corresponding IBC tool. In other words, the current block may be used as the foregoing target block. When the value of the IBCPF is 0, the use of the IBCPF is not allowed for the current block with the corresponding IBC tool. In other words, the current block is not the target block.

In an exemplary embodiment, the target block may be obtained through the foregoing embodiment. In other words, the prediction mode is the IBC, and the use of the IBCPF is also supported. Further, S520 and S530 are performed. Referring to FIG. 5, in S520, the target prediction information of the target block is determined based on reconstruction information of an adjacent region of the target block and original prediction information of the target block.

In this embodiment, a reference sample set in the adjacent region of the target block is obtained. For a target pixel in the target block, a reference sample related to the target pixel is determined in the reference sample set. Further, a predicted value of the target pixel is filtered based on the reconstruction information of the related reference sample.

In an exemplary embodiment, the foregoing adjacent region includes an upper reference sample set in an upper TR row and a TC column above the target block, and a left reference sample set in an LR row and an LC column on the left of the target block. For example, referring to FIG. 11, size information of a target block 110 is M×N. An upper 1 row and a 2M column above the target block 110 are obtained as an upper reference sample set, and a 2N row and a 1 column on the left of the target block are obtained as a left reference sample set. A reference sample in the upper reference sample set of the target block 110 is denoted as r[i], and a reference sample in the left reference sample set is denoted as c[j], where r[0] is equal to c[0].

In an exemplary embodiment, a reconstruction value topPel[i] of the reference sample r[i] in the upper reference sample set of the target block 110 may be represented in the following manner:

for (i=0; i<2M; i++) {
topPel[i]=r[i]
}.

A reconstruction value leftPel[j] of the reference sample c[j] in the left reference sample set of the target block 110 may be represented in the following manner:

for (j=0; i<2N; i++) {
leftPel[j]=c[j]
}.

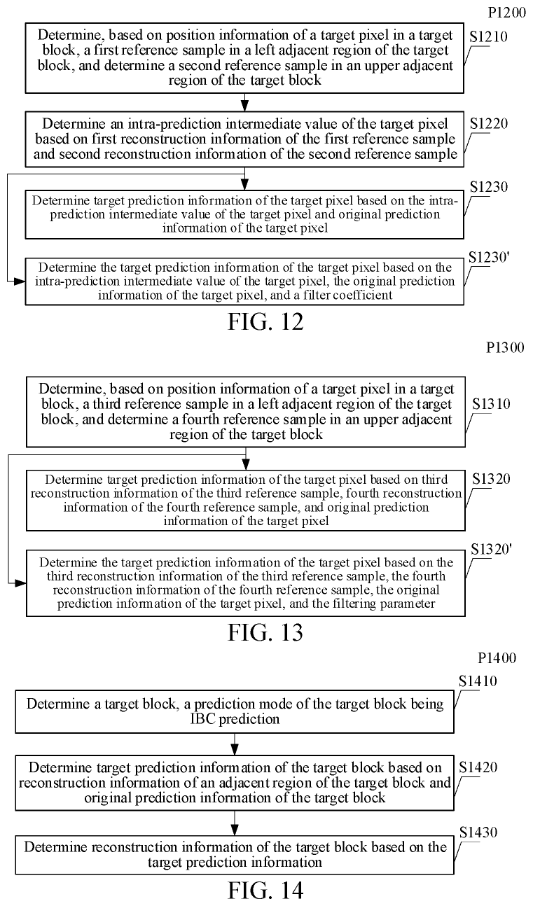

As described above, after the reference sample set of the target block is determined, an original predicted value of the target block may be filtered based on the reconstruction information of the pixel sample in the reference sample set. Exemplarily, for any pixel (denoted as a target pixel) in the target block, the reference sample is determined in the adjacent region (namely, in the foregoing reference sample set) of the target block based on position information of the target pixel in the target block. Then, target prediction information of the target pixel is determined based on reconstruction information of the reference sample and original prediction information of the target pixel. In this way, the original prediction information of the target block is filtered. Exemplarily, FIG. 12 and FIG. 13 respectively provide two filtering modes.

FIG. 12 is a schematic flowchart of a method P1200 for determining target prediction information according to an embodiment of this application. The embodiment may be used as a specific implementation of S520, and may be denoted as a filtering mode A.

S1210: Determine, based on the position information of the target pixel in the target block, a first reference sample in a left adjacent region of the target block, and determine a second reference sample in an upper adjacent region of the target block.

Referring to FIG. 11, the size information of the target block 110 is M×N, the position information of the target pixel (any pixel in the target block) in the target block 110 is (x, y), a value of x being a positive integer not greater than M, a value of y being a positive integer not greater than N, and values of M and N being positive integers.

An embodiment of determining the reference sample of the target pixel:

Embodiment 1: Reference samples (a first reference sample and a second reference sample) of the target pixel are determined with reference to two aspects: the position information (x, y) of the target pixel and the size information of the target block 110. For example, the foregoing first reference sample includes a first pixel c[N+1] related to a horizontal size N of the target block 110 and a second pixel c[y+1] related to a vertical position y of the target pixel. The foregoing second reference sample includes a third pixel r[M+1] related to a vertical size M of the target block and a fourth pixel r[x+1] related to a horizontal position x of the target pixel.

Embodiment 2: A reference sample of the target pixel is determined based on the position information (x, y) of the target pixel. For example, a reference sample may be the second pixel c[y+1] (the first reference sample) related to the vertical position y of the target pixel and the fourth pixel r[x+1] (the second reference sample) related to the horizontal position x of the target pixel.

S1220: Determine an intra-prediction intermediate value of the target pixel based on first reconstruction information of the first reference sample and second reconstruction information of the second reference sample.

A specific implementation of S1220 is described below by using the foregoing “Embodiment 1” as an example.

The first reconstruction information includes a reconstruction value leftPel[N+1] of the first pixel c[N+1] and a reconstruction value leftPel[y+1] of the second pixel c[y+1]. The second reconstruction information includes a reconstruction value topPel[M+1] of the third pixel r[M+1] and a reconstruction value topPel[x+1] of the fourth pixel r[x+1].

S1220-1: Determine an intra prediction vertical component of the target pixel based on reconstruction information of the first pixel, reconstruction information of the fourth pixel, the horizontal size N of the target block, and the vertical position y of the target pixel.

Exemplarily, the intra prediction vertical component predV of the target pixel is determined based on Formula (1).

$$predV = ( ( N - 1 - y ) \times top Pel [ x + 1 ] + ( y + 1 ) \times left Pel [ N + 1 ] + ( N >> 1 ) ) >> Log ( N ) \qquad ( 1 )$$

S1220-2: Determine an intra prediction horizontal component of the target pixel based on reconstruction information of the second pixel, reconstruction information of the third pixel, the vertical size M of the target block, and the horizontal position x of the target pixel.

Exemplarily, the intra prediction horizontal component predH of the target pixel is determined based on Formula (2).

$$predH = ( ( M - 1 - x ) \times left Pel [ y + 1 ] + ( x + 1 ) \times top Pel [ M + 1 ] + ( M >> 1 ) ) >> Log ( M ) \qquad ( 2 )$$

S1220-3: Determine the intra-prediction intermediate value of the target pixel based on the intra prediction vertical component and the intra prediction horizontal component.

Exemplarily, the intra-prediction intermediate value predPlane[x][y] of the target pixel is determined based on Formula (3).

$$pred Plane [ x ] [ y ] = ( predV + predH + 1 ) >> 1 \qquad ( 3 )$$

In another embodiment, the intra-prediction intermediate value of the target pixel may alternatively be determined in another manner, which is not limited in the embodiments of this application.

S1230: Determine target prediction information of the target pixel based on the intra-prediction intermediate value of the target pixel and the original prediction information of the target pixel.

Exemplarily, a target prediction information amount predMatrixTmp[x][y]] of the target pixel is determined based on Formula (4).

$$pred Matrix Tmp [ x ] [ y ] = ( ( predIBC [ x ] [ y ] \times 5 + pred Plane [ x ] [ y ] \times 3 + 4 ) >> 3 ) \qquad ( 4 )$$

S1230′: Determine the target prediction information of the target pixel based on the intra-prediction intermediate value of the target pixel, the original prediction information of the target pixel, and a filter coefficient.

Exemplarily, a target prediction information amount predMatrixTmp[x][y]] of the target pixel is determined based on Formula (5).

$$pred Matrix Tmp [ x ] [ y ] = ( ( predIBC [ x ] [ y ] \times 5 + pred Plane [ x ] [ y ] \times 3 + f [ x ] \times f [ y ] ) >> 3 ) \qquad ( 5 )$$

predIBC[x][y] marks the original prediction information of the target pixel. Filter parameters f[x] and f[y] are related to the position information of the target pixel in the target block. Alternatively, the filter parameters f[x] and f[y] are related to the size information of the target block. Alternatively, the filter parameters f[x] and f[y] are related to the position information in the target block and the size information of the target block. For example, the filter parameters may be determined based on Table 24.

TABLE 24

| Input values | Size of the target block | | | | |
|---|---|---|---|---|---|
| of x and y | 4 | 8 | 16 | 32 | 64 |
| 0 | 24 | 44 | 40 | 36 | 52 |
| 1 | 6 | 25 | 27 | 27 | 44 |
| 2 | 2 | 14 | 19 | 21 | 37 |
| 3 | 0 | 8 | 13 | 16 | 31 |
| 4 | 0 | 4 | 9 | 12 | 26 |
| 5 | 0 | 2 | 6 | 9 | 22 |
| 6 | 0 | 1 | 4 | 7 | 18 |
| 7 | 0 | 1 | 3 | 5 | 15 |
| 8 | 0 | 0 | 2 | 4 | 13 |
| 9 | 0 | 0 | 1 | 3 | 11 |
| 10-63 | 0 | 0 | 0 | 0 | 0 |

FIG. 13 is a schematic flowchart of a method P1300 for determining target prediction information according to another embodiment of this application. The embodiment may be used as another specific implementation of S520, and may be denoted as a filtering mode B.

S1310: Determine, based on the position information of the target pixel in the target block, a third reference sample in a left adjacent region of the target block, and determine a fourth reference sample in an upper adjacent region of the target block.

Referring to FIG. 11, the size information of the target block 110 is M×N, the position information of the target pixel (any pixel in the target block) in the target block 110 is (x, y), a value of x being a positive integer not greater than M, a value of y being a positive integer not greater than N, and values of M and N being positive integers.

An embodiment of determining the reference sample of the target pixel:

Embodiment 1: Reference samples (a third reference sample and a fourth reference sample) of the target pixel are determined with reference to two aspects: the position information (x, y) of the target pixel and the size information of the target block 110. For example, the foregoing third reference sample includes a first pixel c[N+1] related to a horizontal size N of the target block 110 and a second pixel c[y+1] related to a vertical position y of the target pixel. The foregoing fourth reference sample includes a third pixel r [M+1] related to a vertical size M of the target block and a fourth pixel r[x+1] related to a horizontal position x of the target pixel.

Embodiment 2: A reference sample of the target pixel is determined based on the position information (x, y) of the target pixel. For example, a reference sample may be the second pixel c[y+1] (the third reference sample) related to the vertical position y of the target pixel and the fourth pixel r[x+1] (the fourth reference sample) related to the horizontal position x of the target pixel.

S1320: Determine the target prediction information of the target pixel based on third reconstruction information of the third reference sample, fourth reconstruction information of the fourth reference sample, and the original prediction information of the target pixel.

A specific implementation of S1320 is described below by using the foregoing “Embodiment 2” as an example.

Exemplarily, a target prediction information amount predMatrixTmp[x][y] of the target pixel is determined based on Formula (6).

$$pred Matrix Tmp [ x ] [ y ] = Clip1 ( ( left Pel [ y + 1 ] + top Pel [ x + 1 ] + ( 64 - f [ x ] - f [ y ] ) \times predIBC [ x ] [ y ] + 32 ) >> 6 ) \qquad ( 6 )$$

S1320′: Determine target prediction information of the target pixel based on the third reconstruction information of the third reference sample, the fourth reconstruction information of the fourth reference sample, the original prediction information of the target pixel, and the filter parameter.

A specific implementation of S1320′ is described below by using the foregoing “Embodiment 2” as an example.

Exemplarily, a target prediction information amount predMatrixTmp[x][y] of the target pixel is determined based on Formula (7).

$$pred Matrix Tmp [ x ] [ y ] = Clip1 ( ( f [ x ] \times left Pel [ y + 1 ] + f [ y ] \times top Pel [ x + 1 ] + ( 64 - f [ x ] - f [ y ] ) \times predIBC [ x ] [ y ] + 32 ) >> 6 ) \qquad ( 7 )$$

predIBC[x][y] marks the original prediction information of the target pixel. A filter parameter f[x]×f[y] is related to the position information of the target pixel in the target block and the size information of the target block. Exemplarily, the filter parameter may be determined based on Table 24.

In addition to the filtering mode of the predicted value of the target block provided in FIG. 12 and FIG. 13, the prediction information of the target block may also be filtered in another manner. For example, filter on target amount prediction information is implemented by constructing a mathematical model.

The foregoing mathematical model may be a linear model, a polynomial model, a convolutional model, or the like. For example, the mathematical model may be:

f(x)=a×x+b, or

$$f ( x ) = {a}_{0} + {a}_{1} \times x + {a}_{2} \times x \hat{} 2 + … + {a}_{n} \times x \hat{} n ,$$

$$or$$

$$f ( C , N , S , E , W , B ) = {c}_{0} \times C + {c}_{1} \times N + {c}_{2} \times S + {c}_{3} \times E + {c}_{4} \times W + {c}_{5} \times P + {c}_{6} \times B .$$

C represents a sample at a current location, N, S, E, and W are north, south, east, and west samples respectively, and a nonlinear term P=(C×C+midVal)>>bitDepth. An offset item B represents a scalar offset between an input and an output, and is set to an intermediate luminance value. a₀-aₙ and c₀-c₆ are constants, and specific values thereof may be determined based on an actual requirement.

A template parameter may be derived through templates of the current block and the reference block.

Different filtering methods shown above may be combined for use. For example, weighted combinations are performed on predicted values derived by different filtering methods, which is not limited in the embodiments of this application.

Still referring to FIG. 5, in S530, the reconstruction information of the target block is determined based on the target prediction information.

Exemplarily, the prediction information of the target block is filtered in a manner shown in S520, to obtain the target prediction information of the target block. Further, the foregoing target prediction information and corresponding residual information are added, to obtain the reconstruction information of the target block.

In the solution provided in the embodiments of this application, for a target block whose prediction mode is IBC prediction, if the reconstructed block is obtained based on the original prediction information of the target block, a discontinuous boundary may exist on the reconstructed block. Consequently, poor space domain continuity between the block and surrounding pixels thereof may exist. In the embodiments of this application, the target prediction information of the target block is jointly determined based on the reconstruction information of the adjacent region of the target block and the original prediction information of the target block. Reconstruction information of a surrounding region of the target block is added to the target prediction information, which facilitates smooth transition between the target block and the surrounding region thereof, thereby helping reduce space domain discontinuity between the target block and the surrounding region thereof, improving picture quality, and helping improve encoding and decoding performance.

The video decoding method embodiment of this application is described in detail above with reference to FIG. 5 to FIG. 13. An embodiment of a video encoding method in this application is described below with reference to FIG. 14.

FIG. 14 is a schematic flowchart of a video decoding method P1400 according to an embodiment of this application. The method P1400 is performed by an encoder, for example, an electronic device having an encoding function. Referring to FIG. 14, the method P1400 includes S1410 to S1430.

S1410: Determine a target block, a prediction mode of the target block being IBC prediction.

The foregoing target block is a current CU. In this embodiment of this application, the foregoing target block is a CU obtained through prediction by using an IBC prediction mode. Further, in this embodiment of this application, because original prediction information of the target block is filtered, the foregoing target block in this embodiment of this application needs to further support an IBCPF.

In this embodiment of this application, whether the current block is the foregoing target block may be explicitly determined based on a flag related to an IBC mode and/or an IBCPF mode. Specifically, a relevant flag is written into a code stream at an encoder side.

### Embodiment A

In an exemplary embodiment, a first IBC flag of a first-level syntactic structure is written into a code stream, the first IBC flag being configured for indicating whether encoding information of the first-level syntactic structure uses the IBC mode, or configured for indicating whether the IBCPF mode is supported when the IBC mode is used.

As described previously, syntax levels of the encoded bit stream include sequence-level, frame-level, slice-level, block-level, and the like. In the embodiments of this application, the foregoing first-level syntactic structure may be any one of the sequence-level, the frame-level, the slice-level, and the block-level.

Implementation 1 of Embodiment A: The foregoing first-level syntactic structure is sequence-level. It is assumed that the foregoing first IBC flag may be represented as seq_ibc_flag. Semantic information respectively represented by different values of seq_ibc_flag is shown in Table 25.

TABLE 25

| seq_ibc_flag | Semantics |
|---|---|
| 0 | Use of the IBC mode is not allowed |
| 1 | Use of the IBC mode is allowed, but |
| | use of the IBCPF mode is not allowed |
| 2 | Use of the IBC mode and the IBCPF mode is allowed |

A syntactic structure of Table 25 is:

| | |
|---|---|
| seq_ibc_flag | u(2) |

or

| | |
|---|---|
| seq_ibc_flag | ue(v) |

seq_ibc_flag is a sequence header block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of SeqIbcFlag is equal to a value of seq_ibc_flag. If seq_ibc_flag does not exist in the bit stream, the value of SeqIbcFlag is 0.

Implementation 2 of Embodiment A: The foregoing first-level syntactic structure is frame-level. It is assumed that the foregoing first IBC flag may be represented as pic_ibc_flag. Semantic information respectively represented by different values of pic_ibc_flag is shown in Table 26.

TABLE 26

| pic_ibc_flag | Semantics |
|---|---|
| 0 | Use of the IBC mode is not allowed |
| 1 | Use of the IBC mode is allowed, but use |
| | of the IBCPF mode is not allowed |
| 2 | Use of the IBC mode and the IBCPF mode is allowed |

A syntactic structure of Table 26 is:

| | |
|---|---|
| pic_ibc_flag | u(2) |

or

| | |
|---|---|
| pic_ibc_flag | ue(v) |

pic_ibc_flag is a picture header block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of PicIbcFlag is equal to a value of pic_ibc_flag. If pic_ibc_flag does not exist in a bit stream, the value of PicIbcFlag is 0.

Implementation 3 of Embodiment A: The foregoing first-level syntactic structure is slice-level. It is assumed that the foregoing first IBC flag may be represented as slice_ibc_flag. Semantic information respectively represented by different values of slice_ibc_flag is shown in Table 27.

TABLE 27

| slice_ibc_flag | Semantics |
|---|---|
| 0 | Use of the IBC mode is not allowed |
| 1 | Use of the IBC mode is allowed, but use |
| | of the IBCPF mode is not allowed |
| 2 | Use of the IBC mode and the IBCPF mode is allowed |

A syntactic structure of Table 27 is:

| | |
|---|---|
| slice_ibc_flag | u(2) |

or

| | |
|---|---|
| slice_ibc_flag | ue(v) |

slice_ibc_flag is a slice header block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of SliceIbcFlag is equal to a value of slice_ibc_flag. If slice_ibc_flag does not exist in the bit stream, the value of SliceIbcFlag is 0.

Implementation 4 of the method embodiment A: The foregoing first-level syntactic structure is block-level. It is assumed that the foregoing first IBC flag may be represented as cu_ibc_flag. Semantic information respectively represented by different values of cu_ibc_flag is shown in Table 28.

TABLE 28

| cu_ibc_flag | Semantics |
|---|---|
| 0 | Use of the IBC mode is not allowed |
| 1 | Use of the IBC mode is allowed, but use |
| | of the IBCPF mode is not allowed |
| 2 | Use of the IBC mode and the IBCPF mode is allowed |

A syntactic structure of Table 28 is:

| | |
|---|---|
| cu_ibc_flag | ae(v) |

cu_ibc_flag is a block-level block copy mode flag; and
indicates a mode type of a block copy intra prediction mode, a value being ‘0’ indicates that the IBC is not to be used, a value being greater than ‘0’ indicates that the IBC may be used, and indicates whether the IBCPF is allowed. A value of CuIbcFlag is equal to a value of cu_ibc_flag. If cu_ibc_flag does not exist in the bit stream, the value of CuIbcFlag is 0.

In Embodiment A, one flag encoded code stream of each level is configured for marking the foregoing target block through one flag, which helps reduce decoding duration and improve decoding efficiency and performance.

### Embodiment B

In an exemplary embodiment, a first IBC flag and a second IBC flag of a first-level syntactic structure are written into a code stream, the first IBC flag being configured for indicating whether encoding information of the first-level syntactic structure uses the IBC mode, and the second IBC flag being configured for indicating whether the encoding information of the first-level syntactic structure supports the IBCPF mode.

As described previously, syntax levels of the encoded bit stream include sequence-level, frame-level, slice-level, block-level, and the like. In the embodiments of this application, the foregoing first-level syntactic structure may be any one of the sequence-level, the frame-level, the slice-level, and the block-level.

Implementation 1 of Embodiment B: The foregoing first-level syntactic structure is sequence-level. It is assumed that the foregoing first IBC flag may be represented as seq_ibc_flag, and the foregoing second IBC flag may be represented as seq_ibc_pf_flag. Semantic information respectively represented by different values of seq_ibc_flag and seq_ibc_pf_flag is shown in Table 29.

TABLE 29

| seq_ibc_{—} | seq_ibc_{—} | |
|---|---|---|
| flag | pf_flag | Semantics |
| 0 | X | Use of the IBC mode is not allowed |
| 1 | 0 | Use of the IBC mode is allowed, but |
| | | use of the IBCPF mode is not allowed |
| 1 | 1 | Use of the IBC mode and the IBCPF |
| | | mode is allowed |

A syntactic structure of Table 29 is as follows:

| | |
|---|---|
| seq_{—}ibc_{—}flag | u(1) |
| if (SeqIbcFlag) { | |
| seq_{—}ibc_{—}pf_{—}flag | u(1) |
| } | |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.
seq_ibc_pf_flag is a sequence header block copy intra prediction filtering mode flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

Implementation 2 of Embodiment B: The foregoing first-level syntactic structure is sequence-level. It is assumed that the foregoing first IBC flag may be represented as pic_ibc_flag, and the foregoing second IBC flag may be represented as pic_ibc_pf_flag. Semantic information respectively represented by different values pic_ibc_flag and pic_ibc_pf_flag is shown in Table 30.

TABLE 30

| pic_ibc_{—} | pic_ibc_{—} | |
|---|---|---|
| flag | pf_flag | Semantics |
| 0 | X | Use of the IBC mode is not allowed |
| 1 | 0 | Use of the IBC mode is allowed, but |
| | | use of the IBCPF mode is not allowed |
| 1 | 1 | Use of the IBC mode and the IBCPF |
| | | mode is allowed |

A syntactic structure of Table 30 is as follows:

| | |
|---|---|
| pic_{—}ibc_{—}flag | u(1) |
| if (PicIbcFlag) { | |
| pic_{—}ibc_{—}pf_{—}flag | u(1) |
| } | |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.
pic_ibc_pf_flag is a picture header block copy intra prediction filtering mode flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

Implementation 3 of Embodiment B: The foregoing first-level syntactic structure is slice-level. It is assumed that the foregoing first IBC flag may be represented as slice_ibc_flag, and the foregoing second IBC flag may be represented as slice_ibc_pf_flag. Semantic information respectively represented by different slice_ibc_flag and slice_ibc_pf_flag is shown in Table 31.

TABLE 31

| slice_ibc_{—} | slice_ibc_{—} | |
|---|---|---|
| flag | pf_flag | Semantics |
| 0 | X | Use of the IBC mode is not allowed |
| 1 | 0 | Use of the IBC mode is allowed, but |
| | | use of the IBCPF mode is not allowed |
| 1 | 1 | Use of the IBC mode and the IBCPF |
| | | mode is allowed |

A syntactic structure of Table 31 is as follows:

| | |
|---|---|
| slice_{—}ibc_{—}flag | u(1) |
| if (SliceIbcFlag) { | |
| slice_{—}ibc_{—}pf_{—}flag | u(1) |
| } | |

slice_ibc_flag is a slice header block copy intra prediction flag; and
is a binary variable. A value of ‘1’ indicates that the IBC mode may be used, and a value of ‘0’ indicates that the IBC mode is not to be used. A value of SliceIbcFlag is equal to a value of slice_ibc_flag. If slice_ibc_flag does not exist in the bit stream, the value of SliceIbcFlag is 0.
slice_ibc_pf_flag is a slice header block copy intra prediction filtering mode flag; and
is a binary variable. A value of ‘1’ indicates that the IBCPF mode may be used, and a value of ‘0’ indicates that the IBCPF mode is not to be used. A value of SliceIbcPfFlag is equal to a value of slice_ibc_pf_flag. If slice_ibc_pf_flag does not exist in the bit stream, the value of SliceIbcPfFlag is 0.

Implementation 4 of Embodiment B: The foregoing first-level syntactic structure is block-level. It is assumed that the foregoing first IBC flag may be represented as cu_ibc_flag, and the foregoing second IBC flag may be represented as cu_ibc_pf_flag. Semantic information respectively represented by different cu_ibc_flag and cu_ibc_pf_flag is shown in Table 32.

TABLE 32

| cu_ibc_{—} | cu_ibc_pf_{—} | |
|---|---|---|
| flag | flag | Semantics |
| 0 | X | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

A syntactic structure of Table 32 is as follows:

| | |
|---|---|
| cu_{—}ibc_{—}flag | ae(v) |
| if (CuIbcPfFlag) { | |
| cu_{—}ibc_{—}pf_{—}flag | ae(v) |
| } | |

cu_ibc_flag is a block-level block copy intra prediction flag; and
is a binary variable. A value of ‘1’ indicates that the IBC mode may be used, and a value of ‘0’ indicates that the IBC mode is not to be used. A value of CuIbcFlag is equal to a value of cu_ibc_flag. If cu_ibc_flag does not exist in the bit stream, the value of CuIbcFlag is 0.
cu_ibc_pf_flag is a block-level block copy intra prediction filtering mode flag; and
is a binary variable. A value of ‘1’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.

In the foregoing Embodiment B, two flags of each level are written into the code stream, each level marks the foregoing target block through two flags, and the second IBC flag depends on a value of the first IBC flag of the same level. Specifically, when it is determined that the current level does not support the IBC mode through the value of the first IBC flag of the same level, the second IBC flag of the current level does not need to be written into the code stream, thereby helping reduce decoding duration and improving decoding efficiency and performance.

### Embodiment C

A third IBC flag of a second-level syntactic structure is written into the code stream, the third IBC flag being configured for indicating whether encoding information of the second-level syntactic structure uses the IBC mode, or configured for indicating whether the IBCPF mode is supported when the IBC mode is used.

As described above, syntax levels of the encoded bit stream include sequence-level, frame-level, slice-level, block-level, and the like.

In this embodiment of this application, the foregoing second-level syntactic structure may be frame-level, slice-level, or block-level. Specifically, when the foregoing first-level syntactic structure is sequence-level, the second-level syntactic structure is frame-level. Alternatively, when the foregoing first-level syntactic structure is frame-level or sequence-level, the second-level syntactic structure is slice-level. Alternatively, when the first-level syntactic structure is slice-level, frame-level, or sequence-level, the second-level syntactic structure is block-level.

A specific implementation of Embodiment C is similar to a specific implementation of Embodiment A, and a difference lies in that a second-level syntactic structure in Embodiment C cannot be sequence-level.

### Embodiment D

A third IBC flag and a fourth IBC flag of a second-level syntactic structure are written into the code stream, the third IBC flag being configured for indicating whether encoding information of the second-level syntactic structure uses the IBC mode, and the fourth IBC flag being configured for indicating whether the encoding information of the second-level syntactic structure supports the IBCPF mode.

As described above, syntax levels of the encoded bit stream include sequence-level, frame-level, slice-level, block-level, and the like.

In this embodiment of this application, the foregoing second-level syntactic structure may be frame-level, slice-level, or block-level. Specifically, when the foregoing first-level syntactic structure is sequence-level, the second-level syntactic structure is frame-level. Alternatively, when the foregoing first-level syntactic structure is frame-level or sequence-level, the second-level syntactic structure is slice-level. Alternatively, when the first-level syntactic structure is slice-level, frame-level, or sequence-level, the second-level syntactic structure is block-level.

A specific implementation of Embodiment D is similar to a specific implementation of Embodiment B, and a difference lies in that a second-level syntactic structure in Embodiment D cannot be sequence-level.

### Embodiment E

A fourth IBC flag of a second-level syntactic structure is written into the code stream, the fourth IBC flag being configured for indicating whether the encoding information of the second-level syntactic structure supports the IBCPF mode. In this embodiment of this application, the foregoing second-level syntactic structure may be frame-level, slice-level, or block-level.

Implementation 1 of Embodiment E: In this embodiment, the foregoing second-level syntactic structure is frame-level, and the foregoing first-level syntactic structure is sequence-level. Specifically, assuming that the foregoing fourth IBC flag is a frame-level fourth IBC flag pic_ibc_pf_flag, related information may be determined by depending on a sequence-level (the previous-level syntactic structure) flag.

Implementation 1.1: As shown in Table 33, the frame-level fourth IBC flag pic_ibc_pf_flag may determine related information by depending on a sequence-level (the previous-level syntactic structure) flag seq_ibc_flag.

TABLE 33

| seq_ibc_{—} | pic_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 33, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In a picture header:

| | |
|---|---|
| if (SeqIbcFlag) { | |
| pic_ibc_pf_flag | u(n) |
| } | |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of pic_ibc_pf_flag. If pic_ibc_pf_flag does not exist in the bit stream, the value of PicIbcFlag is 0.

Implementation 1.2: As shown in Table 34, the frame-level fourth IBC flag pic_ibc_pf_flag may determine related information by depending on a sequence-level (the previous-level syntactic structure) flag seq_ibc_pf_flag.

TABLE 34

| seq_ibc_{—} | pic_ibc_{—} | |
|---|---|---|
| pf_flag | pf_flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 34, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In a picture header:

| | |
|---|---|
| if (SeqIbcPfFlag) { | |
| pic_ibc_pf_flag | u(n) |
| } | |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_fp_flag. If pic_ibc_pf_flag does not exist in the bit stream, the value of PicIbcPfFlag is 0.

Implementation 2 of Embodiment E: The foregoing second-level syntactic structure is slice-level. As described above, in this embodiment, the foregoing first-level syntactic structure may be sequence-level or frame-level. An example in which the first-level syntactic structure is frame-level is used in Implementation 2.1 and Implementation 2.2. Specifically, when it cannot be excluded that the frame does not use the IBC mode or the IBCPF mode based on the frame-level flag, this embodiment is performed. It is assumed that the foregoing fourth IBC flag may be represented as slice_ibc_pf_flag. A slice-level fourth IBC flag slice_ibc_pf_flag may determine related information by depending on a frame-level (the previous-level syntactic structure) flag.

Implementation 2.1: As shown in Table 35, the slice-level fourth IBC flag slice_ibc_pf_flag may determine related information by depending on a frame-level (the previous-level syntactic structure) flag pic_ibc_flag.

TABLE 35

| pic_ibc_{—} | slice_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 35, in a picture header:

| | |
|---|---|
| pic_ibc_flag | u(1) |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.

In a slice header:

| | |
|---|---|
| if (PicIbcFlag) { | |
| slice_ibc_pf_flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of slice_ibc_pf_flag. If slice_ibc_pf_flag does not exist in the bit stream, the value of PicIbcFlag is 0.

Implementation 2.2: As shown in Table 36, the slice-level fourth IBC flag slice_ibc_pf_flag may determine related information by depending on a frame-level (the previous-level syntactic structure) flag pic_ibc_pf_flag.

TABLE 36

| pic_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 36, in a picture header:

| | |
|---|---|
| pic_ibc_pf_flag | u(1) |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

In a slice header:

| | |
|---|---|
| if (PicIbcPfFlag) { | |
| slice_ibc_pf_flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of slice_ibc_pf_flag. If slice_ibc_pf_flag does not exist in the bit stream, the value of PicIbcPfFlag is 0.

When the second-level syntactic structure is slice-level, in this embodiment, the foregoing first-level syntactic structure may also be sequence-level. An example in which the first-level syntactic structure is sequence-level is used in Implementation 2.3 and Implementation 2.4. A slice-level fourth IBC flag slice_ibc_pf_flag may determine related information by depending on a sequence-level (the previous-level syntactic structure) flag.

Implementation 2.3: As shown in Table 37, the slice-level fourth IBC flag slice_ibc_pf_flag may determine related information by depending on a sequence-level (the previous-level syntactic structure) flag seq_ibc_flag.

TABLE 37

| seq_ibc_{—} | slice_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 37, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In a slice header:

| | |
|---|---|
| if (SeqIbcFlag) { | |
| slice_ibc_pf_flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SeqIbcFlag is equal to a value of slice_ibc_pf_flag. If slice_ibc_pf_flag does not exist in the bit stream, the value of SeqIbcFlag is 0.

Implementation 2.4: As shown in Table 38, the slice-level fourth IBC flag slice_ibc_pf_flag may determine related information by depending on a sequence-level (the previous-level syntactic structure) flag seq_ibc_pf_flag.

TABLE 38

| seq_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 38, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In a slice header:

| | |
|---|---|
| if (SeqIbcPfFlag) { | |
| slice_ibc_pf_flag | u(n) |
| } | |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of slice_ibc_pf_flag. If slice_ibc_pf_flag does not exist in a bit stream, the value of SeqIbcPfFlag is 0.

Implementation 3 of Embodiment E: The foregoing second-level syntactic structure is block-level. As described above, in this embodiment, the foregoing first-level syntactic structure may be sequence-level, frame-level, or slice-level. An example in which the first-level syntactic structure is slice-level is used in Implementation 3.1 and Implementation 3.2. Specifically, when it cannot be excluded that the frame does not use the IBC mode or the IBCPF mode based on the slice-level flag, this embodiment is performed. It is assumed that the foregoing fourth IBC flag may be represented as cu_ibc_pf_flag. A block-level fourth IBC flag cu_ibc_pf_flag may determine related information by depending on a slice-level (the previous-level syntactic structure) flag.

Implementation 3.1: As shown in Table 39, the block-level fourth IBC flag cu_ibc_pf_flag may determine related information by depending on a slice-level (the previous-level syntactic structure) flag slice_ibc_flag.

TABLE 39

| slice_ibc_{—} | cu_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 39, in a slice header:

| | |
|---|---|
| slice_ibc_flag | u(1) |

slice_ibc_flag is a slice header block copy intra prediction flag; and
is a binary variable. A value of ‘1’ indicates that the IBC mode may be used, and a value of ‘0’ indicates that the IBC mode is not to be used. A value of SliceIbcFlag is equal to a value of slice_ibc_flag. If slice_ibc_flag does not exist in the bit stream, the value of SliceIbcFlag is 0.

In an encoding block:

| | |
|---|---|
| if (SliceIbcFlag) { | |
| cu_ibc_pf_flag | ae(v) |

}

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SliceIbcFlag is equal to a value of cu_ibc_pf_flag. If cu_ibc_pf_flag does not exist in the bit stream, the value of SliceIbcFlag is 0.

Implementation 3.2: As shown in Table 40, the block-level fourth IBC flag cu_ibc_pf_flag may determine related information by depending on a slice-level (the previous-level syntactic structure) flag slice_ibc_pf_flag.

TABLE 40

| slice_ibc_pf_{—} | cu_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 40, in a slice header:

| | |
|---|---|
| slice_ibc_pf_flag | u(1) |

slice_ibc_pf_flag is a slice header block copy intra prediction filter flag; and
is a binary variable. A value of ‘1’ indicates that the IBCPF mode may be used, and a value of ‘0’ indicates that the IBCPF mode is not to be used. A value of SliceIbcPfFlag is equal to a value of slice_ibc_pf_flag. If slice_ibc_pf_flag does not exist in the bit stream, the value of SliceIbcPfFlag is 0.

In an encoding block:

| | |
|---|---|
| if (SliceIbcPfFlag) { | |
| cu_ibc_pf_flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SliceIbcPfFlag is equal to a value of cu_ibc_pf_flag. If cu_ibc_pf_flag does not exist in a bit stream, the value of SliceIbcPfFlag is 0.

When the second-level syntactic structure is block-level, in this embodiment, the foregoing first-level syntactic structure may also be frame-level. An example in which the first-level syntactic structure is frame-level is used in Implementation 3.3 and Implementation 3.4. A block-level fourth IBC flag cu_ibc_pf_flag may determine related information by depending on a frame-level (the previous-level syntactic structure) flag.

Implementation 3.3: As shown in Table 41, the block-level fourth IBC flag cu_ibc_pf_flag may determine related information by depending on a frame-level (the previous-level syntactic structure) flag pic_ibc_flag.

TABLE 41

| pic_ibc_{—} | cu_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 41, in a picture header:

| | |
|---|---|
| pic_ibc_flag | u(1) |

pic_ibc_flag is a picture header block copy intra prediction flag; and
is a binary variable. A value of ‘1’ indicates that the IBC mode may be used, and a value of ‘0’ indicates that the IBC mode is not to be used. A value of PicIbcFlag is equal to a value of pic_ibc_flag. If pic_ibc_flag does not exist in a bit stream, the value of PicIbcFlag is 0.

In an encoding block:

| | |
|---|---|
| if (PicIbcFlag) { | |
| cu_ibc_pf_flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of PicIbcFlag is equal to a value of cu_ibc_pf_flag. If cu_ibc_pf_flag does not exist in the bit stream, the value of PicIbcFlag is 0.

Implementation 3.4: As shown in Table 42, the block-level fourth IBC flag cu_ibc_pf_flag may determine related information by depending on a frame-level (the previous-level syntactic structure) flag pic_ibc_pf_flag.

TABLE 42

| pic_ibc_pf_{—} | cu_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 42, in a picture header:

| | |
|---|---|
| pic_ibc_pf_flag | u(1) |

pic_ibc_pf_flag is a picture header block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of pic_ibc_pf_flag. If pic_ibc_pf_flag does not exist in the bit stream, the value of PicIbcPfFlag is 0.

In an encoding block:

| | |
|---|---|
| if (PicIbcPfFlag) { | |
| cu_ibc_pf_flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of PicIbcPfFlag is equal to a value of cu_ibc_pf_flag. If cu_ibc_pf_flag does not exist in the bit stream, the value of PicIbcPfFlag is 0.

When the second-level syntactic structure is block-level, in this embodiment, the foregoing first-level syntactic structure may also be sequence-level. An example in which the first-level syntactic structure is sequence-level is used in Implementation 3.5 and Implementation 3.6. A block-level fourth IBC flag cu_ibc_pf_flag may determine related information by depending on a sequence-level (the previous-level syntactic structure) flag.

Implementation 3.5: As shown in Table 43, the block-level fourth IBC flag cu_ibc_pf_flag may determine related information by depending on a sequence-level (the previous-level syntactic structure) flag seq_ibc_flag.

TABLE 43

| seq_ibc_{—} | cu_ibc_pf_{—} | |
|---|---|---|
| flag | flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 43, in a sequence header:

| | |
|---|---|
| seq_ibc_flag | u(1) |

seq_ibc_flag is a sequence header block copy intra prediction flag; and
is a binary variable. A value of ‘1’ indicates that the IBC mode may be used, and a value of ‘0’ indicates that the IBC mode is not to be used. A value of SeqIbcFlag is equal to a value of seq_ibc_flag. If seq_ibc_flag does not exist in the bit stream, the value of SeqIbcFlag is 0.

In an encoding block:

| | |
|---|---|
| if (SeqIbcFlag) { | |
| cu_ibc_pf_flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SeqIbcFlag is equal to a value of cu_ibc_pf_flag. If cu_ibc_pf_flag does not exist in the bit stream, the value of SeqIbcFlag is 0.

Implementation 3.6: As shown in Table 44, the block-level fourth IBC flag cu_ibc_pf_flag may determine related information by depending on a sequence-level (the previous-level syntactic structure) flag seq_ibc_pf_flag.

TABLE 44

| seq_ibc_{—} | slice_ibc_{—} | |
|---|---|---|
| pf_flag | pf_flag | Semantics |
| 0 | x | Use of the IBC mode is not allowed |
| 1 | 0 | Use of the IBC mode is allowed, but |
| | | use of the IBCPF mode is not allowed |
| 1 | 1 | Use of the IBC mode and the IBCPF mode |
| | | is allowed |

For a syntactic structure in Table 44, in a sequence header:

| | |
|---|---|
| seq_ibc_pf_flag | u(1) |

seq_ibc_pf_flag is a sequence header block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of seq_ibc_pf_flag. If seq_ibc_pf_flag does not exist in the bit stream, the value of SeqIbcPfFlag is 0.

In an encoding block:

| | |
|---|---|
| if (SeqIbcPfFlag) { | |
| cu_ibc_pf_flag | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of SeqIbcPfFlag is equal to a value of cu_ibc_pf_flag. If cu_ibc_pf_flag does not exist in the bit stream, the value of SeqIbcPfFlag is 0.

In the foregoing Embodiment E, when a flag included in a lower level is written into the code stream, the foregoing target block may be marked by depending on a flag above the level (a higher layer). The target block is determined with reference to related flags of two levels, thereby providing a flexible determining manner, and helping reduce time consumption of encoding and decoding and improve encoding and decoding performance.

### Embodiment F

A block-level fifth IBC flag is written into the code stream, the fifth IBC flag being configured for indicating whether the current block supports an IBCPF mode, and different types of the supported IBCPF modes.

Exemplarily, the foregoing fifth IBC flag may be represented as cu_ibc_pf_index. Table 45 shows related semantics of cu_ibc_pf_index.

TABLE 45

| cu_ibc_pf_flag | Semantics |
|---|---|
| 0 | The IBCPF mode is not used |
| 1 | An IBCPF mode 1 is used |
| 2 | An IBCPF mode 2 is used |

For a syntactic structure in Table 45, in a coding block:

| | |
|---|---|
| cu_ibc_pf_flag | ae(v) |

cu_ibc_pf_flag is a block-level block copy intra prediction filter flag; and
is a binary variable. A value being greater than ‘0’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.

### Embodiment G

A block-level fourth IBC flag and a block-level fifth IBC flag are written into the code stream, the fourth IBC flag being configured for indicating whether the current block supports the IBCPF mode, and the fifth IBC flag being configured for indicating different types of the supported IBCPF modes.

Exemplarily, the foregoing fourth IBC flag may be represented as cu_ibc_pf_flag, and the foregoing fifth IBC flag may be represented as cu_ibc_pf_index. Table 46 shows related semantics of cu_ibc_pf_flag and cu_ibc_pf_index.

TABLE 46

| cu_ibc_pf_flag | cu_ibc_pf_index | Semantics |
|---|---|---|
| 0 | x | The IBCPF mode is not used |
| 1 | 0 | An IBCPF mode 1 is used |
| 1 | 1 | An IBCPF mode 2 is used |

For a syntactic structure in Table 46, in a coding block:

| | |
|---|---|
| cu_ibc_pf_flag | ae(v) |
| if (CuIbcPfFlag) { | |
| cu_ibc_pf_index | ae(v) |
| } | |

cu_ibc_pf_flag is a block-level block copy intra prediction filter flag; and
is a binary variable. A value of ‘1’ indicates that the IBCPF mode may be used, and a value of ‘0’ indicates that the IBCPF mode is not to be used. A value of CuIbcPfFlag is equal to a value of cu_ibc_pf_flag. If cu_ibc_pf_flag does not exist in the bit stream, the value of CuIbcPfFlag is 0.
cu_ibc_pf_index is a block-level block copy intra prediction filter index; and
represents a used IBCPF mode. A value of CuIbcPfIndex is equal to a value of cu_ibc_pf_index. If cu_ibc_pf_index does not exist in the bit stream, the value of CuIbcPfIndex is 0.

In an exemplary embodiment, in addition to marking the target block by writing the foregoing flag into the code stream, the target block may be marked in the following manner. The target information is written into the code stream, the target information being configured for determining whether the current block supports the IBCPF mode.

Embodiment 1: The foregoing target information is a type of a picture in which the current block is located.

Specifically, use of the IBCPF mode is allowed only for an I-type picture. For a non-I picture, the IBCPF mode is not used, and a syntax element related to an IBCPF does not need to be written into the code stream, to improve encoding efficiency.

Embodiment 2: The foregoing target information is a color component of the current block.

For example, use of the IBCPF is only allowed for a luminance component, or the use of the IBCPF is only allowed for a chrominance component.

Use of the IBCPF is allowed only when the current block is a specific color component. For example, the IBCPF is used only on a luminance component Y, or the IBCPF is used only on a chrominance component U or V, or the use of the IBCPF is allowed for luminance components Y, U, and V.

Embodiment 3: The foregoing target information is a size of the current block.

Specifically, the use of the IBCPF is allowed when a block size satisfies a condition. If the current block size does not satisfy the condition, use of the IBCPF is not allowed. The block size includes one or more of a width, a height, or an area. The foregoing condition may be greater than a first threshold, greater than or equal to a second threshold, less than a third threshold, less than or equal to a fourth threshold, or the like. The foregoing plurality of thresholds are not limited, and may be determined based on an actual situation.

For example, use of the IBCPF is allowed only when the current block area (width×height) is greater than 64; or use of the IBCPF is allowed when the current block width is less than or equal to 64; or use of the IBCPF is allowed when the current block height is less than or equal to 64; or the like.

Embodiment 4: The foregoing target information is a type of a picture in which the current block is located.

When the use of the IBCPF is allowed in a non-specific picture type (for example, a non-I picture), then IBCPF flag is written into a code stream for a non-specific type of picture.

Embodiment 5: The foregoing target information is an adaptive block vector resolution (ABVR) of the current block.

Specifically, when the ABVR of the current block satisfies a specific condition, use of the IBCPF is allowed. If a value of the ABVR of the current block does not satisfy the condition, use of the IBCPF is not allowed.

Exemplarily, when the ABVR of the current block is a subset of an available ABVR list, use of the IBCPF is allowed. For example, if the available ABVR list is {1-pel, 4 pel}, a block-level IBCPF is written into the code stream only when the current block vector resolution is 1-pel, or use of the IBCPF is allowed only when the current block vector resolution is 4-pel. For another example, if the available ABVR list is {1/4 pel, 1-pel, 4 pel}, use of the IBCPF is allowed only when the current block vector resolution is 1-pel; or use of the IBCPF is allowed only when the current block vector resolution is 1-pel or 4-pel, and the like.

Embodiment 6: The foregoing target information is a vector difference of the current block.

Exemplarily, only when a current block vector difference (BVD) satisfies a condition, the use of the IBCPF is allowed. If a value of the block vector difference of the current block does not satisfy the condition, a syntax element related to a block-level IBCPF does not need to be written into a code stream, to improve encoding efficiency. For example, the foregoing condition is that an absolute value of a horizontal BVD and/or a vertical BVD of the current block satisfies a specific threshold. For example, the foregoing condition may be greater than a first threshold, greater than or equal to a second threshold, less than a third threshold, less than or equal to a fourth threshold, or the like. The foregoing plurality of thresholds are not limited, and may be determined based on an actual situation. For another example, use of the IBCPF is allowed only when the horizontal BVD and the vertical BVD of the current block are both equal to 0.

Embodiment 7: The foregoing target information is a vector index of the current block.

Exemplarily, when the vector index of the current block satisfies a condition, the se of the IBCPF is allowed. If the prediction block vector index of the current block does not satisfy the condition, a syntax element related to a block-level IBCPF does not need to be written into the code stream, to improve encoding efficiency. For example, the foregoing condition is that an absolute value of the block vector prediction index (bvp_idx) satisfies a specific threshold. For example, the foregoing condition may be greater than a first threshold, greater than or equal to a second threshold, less than a third threshold, less than or equal to a fourth threshold, or the like. The foregoing plurality of thresholds are not limited, and may be determined based on an actual situation.

Embodiment 8: The foregoing target information is an IBC tool corresponding to an IBC prediction mode of the current block.

In an exemplary embodiment, use of the IBCPF is allowed when the IBC tool level of the current block satisfies one or more of the following conditions.
1) The prediction block vector index is less than or equal to a first preset value. For example, the first preset value is 2;
2) The block vector difference is less than or equal to a second preset value. For example, the second preset value is 0; and
3) A precision of the ABVR satisfies a preset precision set. For example, the preset precision set is a precision less than or equal to 1 pel.

In another exemplary embodiment, when one or more IBC tools in Table 47 are not used, use of the IBCPF is allowed.

TABLE 47

| IBC tool | IBCPF |
|---|---|
| ABVR | 0 |
| SIBC, RRIBC, FIBC | 0 |
| IBC-PC, IBC-LIC | 0 |
| IBC-MBVD | 0 |
| IBC-TM, IBC-TM-AMVP, IBC-TM-MRG | 0 |
| IBC-BI-PRED | 0 |
| IBC-CHIP | 0 |
| IBC-GPM | 0 |

In Table 46, when the value of the IBCPF is 1, the use of the IBCPF is allowed for the current block with a corresponding IBC tool. In other words, the current block may be used as the foregoing target block. When the value of the IBCPF is 0, the use of the IBCPF is not allowed for the current block with the corresponding IBC tool. In other words, the current block is not the target block.

In an exemplary embodiment, the target block may be determined through the foregoing embodiment. In other words, the prediction mode is the IBC, and the use of the IBCPF is also supported. Further, S1420 and S1430 are performed.

S1420: Determine target prediction information of the target block based on reconstruction information of an adjacent region of the target block and original prediction information of the target block.

In this embodiment, a reference sample set in the adjacent region of the target block is obtained. For a target pixel in the target block, a reference sample related to the target pixel is determined in the reference sample set. Further, a predicted value of the target pixel is filtered based on the reconstruction information of the related reference sample.

In an exemplary embodiment, the foregoing adjacent region includes an upper reference sample set in an upper TR row and a TC column above the target block, and a left reference sample set in an LR row and an LC column on the left of the target block. For example, referring to FIG. 11, size information of a target block 110 is M×N. An upper 1 row and a 2M column above the target block 110 are obtained as an upper reference sample set, and a 2N row and a 1 column on the left of the target block are obtained as a left reference sample set. A reference sample in the upper reference sample set of the target block 110 is denoted as r[i], and a reference sample in the left reference sample set is denoted as c[j], where r[0] is equal to c[0].

In an exemplary embodiment, a reconstruction value topPel[i] of the reference sample r[i] in the upper reference sample set of the target block 110 may be represented in the following manner:

for (i=0; i<2M; i++) {
topPel[i]=r[i]
}.

A reconstruction value leftPel[j] of the reference sample c[j] in the left reference sample set of the target block 110 may be represented in the following manner:

for (j=0; i<2N; i++) {
leftPel[j]=c[j]
}.

As described above, after the reference sample set of the target block is determined, an original predicted value of the target block may be filtered based on the reconstruction value of the pixel sample in the reference sample set. FIG. 12 and FIG. 13 provide two filtering modes.

FIG. 12 is a schematic flowchart of a method P1200 for determining target prediction information according to an embodiment of this application. The embodiment may be used as a specific implementation of S520, and may be denoted as a filtering mode A.

S1210: Determine, based on the position information of the target pixel in the target block, a first reference sample in a left adjacent region of the target block, and determine a second reference sample in an upper adjacent region of the target block.

Referring to FIG. 11, the size information of the target block 110 is M×N, the position information of the target pixel (any pixel in the target block) in the target block 110 is (x, y), a value of x being a positive integer not greater than M, a value of y being a positive integer not greater than N, and values of M and N being positive integers.

An embodiment of determining the reference sample of the target pixel:

Embodiment 1: Reference samples (a first reference sample and a second reference sample) of the target pixel are determined with reference to two aspects: the position information (x, y) of the target pixel and the size information of the target block 110. For example, the foregoing first reference sample includes a first pixel c[N+1] related to a horizontal size N of the target block 110 and a second pixel c[y+1] related to a vertical position y of the target pixel. The foregoing second reference sample includes a third pixel r[M+1] related to a vertical size M of the target block and a fourth pixel r[x+1] related to a horizontal position x of the target pixel.

Embodiment 2: A reference sample of the target pixel is determined based on the position information (x, y) of the target pixel. For example, a reference sample may be the second pixel c[y+1] (the first reference sample) related to the vertical position y of the target pixel and the fourth pixel r[x+1] (the second reference sample) related to the horizontal position x of the target pixel.

S1220: Determine an intra-prediction intermediate value of the target pixel based on first reconstruction information of the first reference sample and second reconstruction information of the second reference sample.

A specific implementation of S1220 is described below by using the foregoing “Embodiment 1” as an example.

The first reconstruction information includes a reconstruction value leftPel[N+1] of the first pixel c[N+1] and a reconstruction value leftPel[y+1] of the second pixel c[y+1]. The second reconstruction information includes a reconstruction value topPel[M+1] of the third pixel r[M+1]] and a reconstruction value topPel[x+1] of the fourth pixel r[x+1].

S1220-1: Determine an intra prediction vertical component of the target pixel based on reconstruction information of the first pixel, reconstruction information of the fourth pixel, the horizontal size N of the target block, and the vertical position y of the target pixel.

Exemplarily, the intra prediction vertical component predV of the target pixel is determined based on Formula (1).

$$predV = ( ( N - 1 - y ) \times top Pel [ x + 1 ] + ( y + 1 ) \times left Pel [ N + 1 ] + ( N >> 1 ) ) >> Log ( N ) \qquad ( 1 )$$

S1220-2: Determine an intra prediction horizontal component of the target pixel based on reconstruction information of the second pixel, reconstruction information of the third pixel, the vertical size M of the target block, and the horizontal position x of the target pixel.

Exemplarily, the intra prediction horizontal component predH of the target pixel is determined based on Formula (2).

$$predH = ( ( M - 1 - x ) \times left Pel [ y + 1 ] + ( x + 1 ) \times top Pel [ M + 1 ] + ( M >> 1 ) ) >> Log ( M ) \qquad ( 2 )$$

S1220-3: Determine the intra-prediction intermediate value of the target pixel based on the intra prediction vertical component and the intra prediction horizontal component.

Exemplarily, the intra-prediction intermediate value predPlane[x][y] of the target pixel is determined based on Formula (3).

$$pred Plane [ x ] [ y ] = ( predV + predH + 1 ) >> 1 \qquad ( 3 )$$

In another embodiment, the intra-prediction intermediate value of the target pixel may alternatively be determined in another manner, which is not limited in the embodiments of this application.

S1230: Determine target prediction information of the target block based on the intra-prediction intermediate value of the target pixel and the original prediction information of the target block.

Exemplarily, a target prediction information amount predMatrixTmp[x][y]] of the target pixel is determined based on Formula (4).

$$pred Matrix Tmp [ x ] [ y ] = ( ( predIBC [ x ] [ y ] \times 5 + pred Plane [ x ] [ y ] \times 3 + 4 ) >> 3 ) \qquad ( 4 )$$

S1230′: Determine the target prediction information of the target block based on the intra-prediction intermediate value of the target pixel, the original prediction information of the target block, and a filter coefficient.

Exemplarily, a target prediction information amount predMatrixTmp[x][y] of the target pixel is determined based on Formula (5).

$$pred Matrix Tmp [ x ] [ y ] = ( ( predIBC [ x ] [ y ] \times 5 + pred Plane [ x ] [ y ] \times 3 + f [ x ] \times f [ y ] ) >> 3 ) \qquad ( 5 )$$

predIBC[x][y] marks the original prediction information of the target pixel. filter parameters f[x] and f[y] are related to the position information of the target pixel in the target block. Alternatively, the filter parameters f[x] and f[y] are related to the size information of the target block. Alternatively, the filter parameters f[x] and f[y] are related to the position information in the target block and the size information of the target block. For example, the filter parameters may be determined based on Table 48.

TABLE 48

| Input values | Size of the target block | | | | |
|---|---|---|---|---|---|
| of x and y | 4 | 8 | 16 | 32 | 64 |
| 0 | 24 | 44 | 40 | 36 | 52 |
| 1 | 6 | 25 | 27 | 27 | 44 |
| 2 | 2 | 14 | 19 | 21 | 37 |
| 3 | 0 | 8 | 13 | 16 | 31 |
| 4 | 0 | 4 | 9 | 12 | 26 |
| 5 | 0 | 2 | 6 | 9 | 22 |
| 6 | 0 | 1 | 4 | 7 | 18 |
| 7 | 0 | 1 | 3 | 5 | 15 |
| 8 | 0 | 0 | 2 | 4 | 13 |
| 9 | 0 | 0 | 1 | 3 | 11 |
| 10-63 | 0 | 0 | 0 | 0 | 0 |

FIG. 13 is a schematic flowchart of a method P1300 for determining target prediction information according to another embodiment of this application. The embodiment may be used as another specific implementation of S520, and may be denoted as a filtering mode B.

S1310: Determine, based on the position information of the target pixel in the target block, a third reference sample in a left adjacent region of the target block, and determine a fourth reference sample in an upper adjacent region of the target block.

Referring to FIG. 11, the size information of the target block 110 is M×N, the position information of the target pixel (any pixel in the target block) in the target block 110 is (x, y), a value of x being a positive integer not greater than M, a value of y being a positive integer not greater than N, and values of M and N being positive integers.

An embodiment of determining the reference sample of the target pixel:

Embodiment 1: Reference samples (a third reference sample and a fourth reference sample) of the target pixel are determined with reference to two aspects: the position information (x, y) of the target pixel and the size information of the target block 110. For example, the foregoing third reference sample includes a first pixel c[N+1] related to a horizontal size N of the target block 110 and a second pixel c[y+1] related to a vertical position y of the target pixel. The foregoing fourth reference sample includes a third pixel r[M+1] related to a vertical size M of the target block and a fourth pixel r[x+1] related to a horizontal position x of the target pixel.

Embodiment 2: A reference sample of the target pixel is determined based on the position information (x, y) of the target pixel. For example, a reference sample may be the second pixel c[y+1] (the third reference sample) related to the vertical position y of the target pixel and the fourth pixel r[x+1] (the fourth reference sample) related to the horizontal position x of the target pixel.

S1320: Determine target prediction information of the target block based on the third reconstruction information of the third reference sample, the fourth reconstruction information of the fourth reference sample, and the original prediction information of the target block.

A specific implementation of S1320 is described below by using the foregoing “Embodiment 2” as an example.

Exemplarily, a target prediction information amount predMatrixTmp[x][y] of the target pixel is determined based on Formula (6).

$$pred Matrix Tmp [ x ] [ y ] = Clip1 ( ( left Pel [ y + 1 ] + top Pel [ x + 1 ] + ( 64 - f [ x ] - f [ y ] ) \times predIBC [ x ] [ y ] + 32 ) >> 6 ) \qquad ( 6 )$$

S1320′: Determine the target prediction information of the target block based on the third reconstruction information of the third reference sample, the fourth reconstruction information of the fourth reference sample, the original prediction information of the target block, and the filter parameter.

A specific implementation of S1320′ is described below by using the foregoing “Embodiment 2” as an example.

Exemplarily, a target prediction information amount predMatrixTmp[x][y] of the target pixel is determined based on Formula (7).

$$pred Matrix Tmp [ x ] [ y ] = Clip1 ( ( f [ x ] \times left Pel [ y + 1 ] + f [ y ] \times top Pel [ x + 1 ] + ( 64 - f [ x ] - f [ y ] ) \times predIBC [ x ] [ y ] + 32 ) >> 6 ) \qquad ( 7 )$$

predIBC[x][y] marks the original prediction information of the target pixel. A filter parameter f[x]×f[y] is related to the position information of the target pixel in the target block and the size information of the target block. Exemplarily, the filter parameter may be determined based on Table 24.

In addition to the filtering mode of the predicted value of the target block provided in FIG. 12 and FIG. 13, the prediction information of the target block may also be filtered in another manner. For example, filter on target amount prediction information is implemented by constructing a mathematical model.

The foregoing mathematical model may be a linear model, a polynomial model, a convolutional model, or the like. For example, the mathematical model may be:

f(x)=a×x+b, or

$$f ( x ) = {a}_{0} + {a}_{1} \times x + {a}_{2} \times x \hat{} 2 + … + {a}_{n} \times x \hat{} n ,$$

$$or$$

$$f ( C , N , S , E , W , B ) = {c}_{0} \times C + {c}_{1} \times N + {c}_{2} \times S + {c}_{3} \times E + {c}_{4} \times W + {c}_{5} \times P + {c}_{6} \times B .$$

C represents a sample at a current location, N, S, E, and W are north, south, east, and west samples respectively, and a nonlinear term P=(C×C+midVal)>>bitDepth. An offset item B represents a scalar offset between an input and an output, and is set to an intermediate luminance value. a₀-aₙ and c₀-c₆ are constants, and specific values thereof may be determined based on an actual requirement.

A template parameter may be derived through templates of the current block and the reference block.

Different filtering methods shown above may be combined for use. For example, weighted combinations are performed on predicted values derived by different filtering methods, which is not limited in the embodiments of this application.

S1430: Determine reconstruction information of the target block based on the target prediction information.

Exemplarily, the prediction information of the target block is filtered in a manner shown in S1420, to obtain the target prediction information of the target block. Further, the foregoing target prediction information and corresponding residual information are added, to obtain the reconstruction information of the target block.

In the solution provided in the embodiments of this application, for a target block whose prediction mode is IBC prediction, if the reconstructed block is obtained based on the original prediction information of the target block, a discontinuous boundary may exist on the reconstructed block. Consequently, poor space domain continuity between the block and surrounding pixels thereof may exist. In the embodiments of this application, the target prediction information of the target block is jointly determined based on the reconstruction information of the adjacent region of the target block and the original prediction information of the target block. Reconstruction information of a surrounding region of the target block is added to the target prediction information, which facilitates smooth transition between the target block and the surrounding region thereof, thereby helping reduce space domain discontinuity between the target block and the surrounding region thereof, improving picture quality, and helping improve encoding and decoding performance.

The embodiment of the encoding method in this application is described in detail above with reference to FIG. 14. An embodiment of the apparatus in this application is described in detail below.

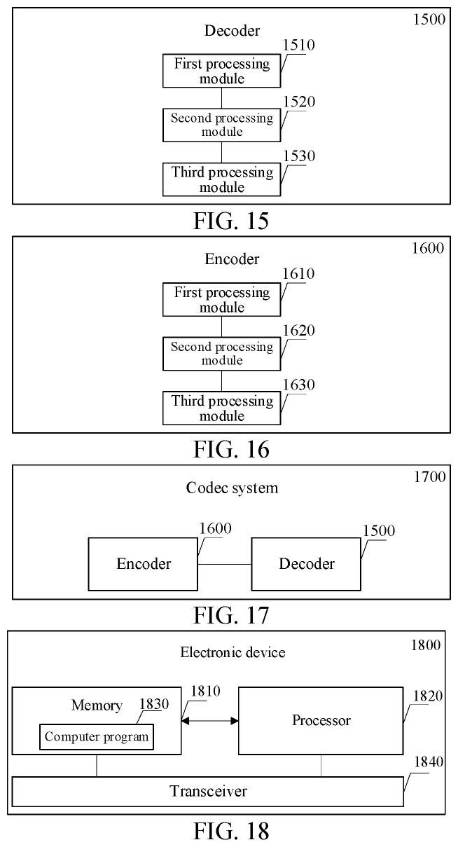

FIG. 15 is a schematic structural diagram of a decoder 1500 according to an embodiment of this application. The decoder 1500 includes a first determining module 1510, a second determining module 1520, and a third determining module 1530.

The foregoing first determining module 1510 is configured to parse a code stream, and determine a target block, a prediction mode of the target block being IBC prediction. The foregoing second determining module 1520 is configured to determine target prediction information of the target block based on reconstruction information of an adjacent region of the target block and original prediction information of the target block. The foregoing third determining module 1530 is configured to determine reconstruction information of the target block based on the target prediction information.

In an exemplary embodiment, based on the foregoing solution, the foregoing second determining module 1520 includes a determining unit and a filter unit.

The foregoing determining unit is configured to determine a reference sample in the adjacent region of the target block based on position information of a target pixel in the target block, the target pixel being any pixel in the target block. The foregoing filter unit is configured to determine target prediction information of the target pixel based on reconstruction information of the reference sample and original prediction information of the target pixel, prediction information of the target block including the target prediction information of the target pixel.

In an exemplary embodiment, based on the foregoing solution, the foregoing determining unit is specifically configured to determine, based on the position information of the target pixel in the target block, a first reference sample in a left adjacent region of the target block, and determine a second reference sample in an upper adjacent region of the target block. The foregoing filter unit is specifically configured to: determine an intra-prediction intermediate value of the target pixel based on first reconstruction information of the first reference sample and second reconstruction information of the second reference sample; and determine the target prediction information of the target pixel based on the intra-prediction intermediate value of the target pixel and the original prediction information of the target pixel; or determine the target prediction information of the target pixel based on the intra-prediction intermediate value of the target pixel, the original prediction information of the target pixel, and a filter coefficient.

In an exemplary embodiment, based on the foregoing solution, the size information of the target block is M×N, and the position information of the target pixel in the target block is (x, y), a value of x being a positive integer not greater than M, a value of y being a positive integer not greater than N, and values of M and N being positive integers.

The first reference sample includes a first pixel related to a horizontal size N of the target block and a second pixel related to a vertical position y of the target pixel. The second reference sample includes a third pixel related to a vertical size M of the target block and a fourth pixel related to a horizontal position x of the target pixel.

The filter unit is further specifically configured to: determine an intra prediction vertical component of the target pixel based on reconstruction information of the first pixel, reconstruction information of the fourth pixel, the horizontal size N of the target block, and the vertical position y of the target pixel; determine an intra prediction horizontal component of the target pixel based on reconstruction information of the second pixel, reconstruction information of the third pixel, the vertical size M of the target block, and the horizontal position x of the target pixel; and determine the intra-prediction intermediate value of the target pixel based on the intra prediction vertical component and the intra prediction horizontal component.

In an exemplary embodiment, based on the foregoing solution, the foregoing determining unit is specifically configured to determine, based on the position information of the target pixel in the target block, a third reference sample in a left adjacent region of the target block, and determine a fourth reference sample in an upper adjacent region of the target block. The foregoing filter unit is specifically configured to: determine the target prediction information of the target pixel based on third reconstruction information of the third reference sample, fourth reconstruction information of the fourth reference sample, and the original prediction information of the target pixel; or determine the target prediction information of the target pixel based on the third reconstruction information of the third reference sample, the fourth reconstruction information of the fourth reference sample, the original prediction information of the target pixel, and a filter parameter.

In an exemplary embodiment, based on the foregoing solution, the filter parameter is related to at least one of the position information of the target pixel in the target block and the size information of the target block.

In an exemplary embodiment, based on the foregoing solution, the first determining module 1510 is specifically configured to: parse the code stream, to obtain a first IBC flag of a first-level syntactic structure, the first IBC flag being configured for indicating whether encoding information of the first-level syntactic structure of the code stream uses an IBC mode, or configured for indicating whether an IBCPF mode is supported when the IBC mode is used; determine that the encoding information of the first-level syntactic structure does not include the target block when the first IBC flag indicates that the encoding information of the first-level syntactic structure does not use the IBC mode, or when the first IBC flag indicates that the encoding information of the first-level syntactic structure uses the IBC mode and does not support the IBCPF mode; determine whether the first-level syntactic structure is block-level when the first IBC flag indicates that the encoding information of the first-level syntactic structure uses the IBC mode and supports the IBCPF mode; determine a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

In an exemplary embodiment, based on the foregoing solution, the first determining module 1510 is specifically configured to: parse the code stream, to obtain a first IBC flag of a first-level syntactic structure, the first IBC flag being configured for indicating whether encoding information of the first-level syntactic structure in the code stream uses an IBC mode; determine that the encoding information of the first-level syntactic structure does not include the target block when the first IBC flag indicates that the encoding information of the first-level syntactic structure does not use the IBC mode; parse the code stream, to obtain a second IBC flag of the first-level syntactic structure when the first IBC flag indicates that the encoding information of the first-level syntactic structure uses the IBC mode, the second IBC flag being configured for indicating whether the encoding information of the first-level syntactic structure in the code stream supports an IBCPF mode; determine that the encoding information of the first-level syntactic structure does not include the target block when the second IBC flag indicates that the encoding information of the first-level syntactic structure does not support use of the IBCPF mode; determine whether the first-level syntactic structure is block-level when the second IBC flag indicates that the encoding information of the first-level syntactic structure uses the IBC mode and supports the IBCPF mode; determine a current block as the target block when the first-level syntactic structure is block-level; and parse the code stream to obtain a flag of a next-level syntactic structure when the first-level syntactic structure is not block-level, to determine the target block based on the flag of the next-level syntactic structure.

In an exemplary embodiment, based on the foregoing solution, the first determining module 1510 is further specifically configured to: parse the code stream to obtain a third IBC flag of a second-level syntactic structure when the first-level syntactic structure is not block-level, the third IBC flag being configured for indicating whether encoding information of the second-level syntactic structure in the code stream uses the IBC mode, or configured for indicating whether the IBCPF mode is supported when the IBC mode is used; determine that the encoding information of the second-level syntactic structure does not include the target block when the third IBC flag indicates that the encoding information of the second-level syntactic structure does not use the IBC mode, or when the third IBC flag indicates that the encoding information of the second-level syntactic structure uses the IBC mode and does not support the IBCPF mode; determine whether the second-level syntactic structure is block-level when the third IBC flag indicates that the encoding information of the second-level syntactic structure uses the IBC mode and supports the IBCPF mode; determine the current block as the target block when the second-level syntactic structure is block-level; and parse the code stream to obtain a flag of a next-level syntactic structure when the second-level syntactic structure is not block-level, to determine the target block based on the flag of the next-level syntactic structure.

In an exemplary embodiment, based on the foregoing solution, the first determining module 1510 is further specifically configured to: parse the code stream to obtain a third IBC flag of a second-level syntactic structure when the first-level syntactic structure is not block-level, the third IBC flag being configured for indicating whether encoding information of the second-level syntactic structure in the code stream uses the IBC mode; parse the code stream to obtain a fourth IBC flag of the second-level syntactic structure when the third IBC flag indicates that the encoding information of the second-level syntactic structure uses the IBC mode, the fourth IBC flag being configured for indicating whether the encoding information of the second-level syntactic structure supports the IBCPF mode; determine that the encoding information of the second-level syntactic structure does not include the target block when the fourth IBC flag indicates that the encoding information of the second-level syntactic structure does not support the use of the IBCPF mode; determine whether the second-level syntactic structure is block-level when the fourth IBC flag indicates that the encoding information of the second-level syntactic structure supports the IBCPF mode; determining a current block as the target block when the second-level syntactic structure is block-level; and parse the code stream to obtain a flag of a next-level syntactic structure when the second-level syntactic structure is not block-level, to determine the target block based on the flag of the next-level syntactic structure.

In an exemplary embodiment, based on the foregoing solution, the first determining module 1510 is further specifically configured to: parse the code stream to obtain a fourth IBC flag of the second-level syntactic structure when the first-level syntactic structure is not block-level, the fourth IBC flag being configured for indicating whether the encoding information of the second-level syntactic structure supports the IBCPF mode; determine that the encoding information of the second-level syntactic structure does not include the target block when the fourth IBC flag indicates that the encoding information of the second-level syntactic structure does not support the use of the IBCPF mode; determine whether the second-level syntactic structure is block-level when the fourth IBC flag indicates that the encoding information of the second-level syntactic structure supports the IBCPF mode; determine a current block as the target block when the second-level syntactic structure is block-level; and parse the code stream to obtain a flag of a next-level syntactic structure when the second-level syntactic structure is not block-level, to determine the target block based on the flag of the next-level syntactic structure.

In an exemplary embodiment, based on the foregoing solution, the second-level syntactic structure is frame-level, and the first-level syntactic structure is sequence-level; or the second-level syntactic structure is slice-level, and the first-level syntactic structure is frame-level or sequence-level; or the second-level syntactic structure is block-level, and the first-level syntactic structure is slice-level, frame-level, or sequence-level; or the first-level syntactic structure is block-level.

In an exemplary embodiment, based on the foregoing solution, the first determining module 1510 is further specifically configured to: parse the code stream to obtain a block-level fifth IBC flag, the fifth IBC flag being configured for indicating whether the current block supports an IBCPF mode, and different types of the supported IBCPF modes; determine that the current block is not the target block when the fifth IBC flag indicates that the current block does not support the IBCPF mode; and determine the current block as the target block when the fifth IBC flag indicates that the current block supports any type of IBCPF mode.

In an exemplary embodiment, based on the foregoing solution, the first determining module 1510 is further specifically configured to: parse the code stream to obtain target information, and determine whether the current block supports the IBCPF mode based on the target information; and determine that the current block is the target block when it is determined that the current block supports the IBCPF mode,
the target information including one or more of the following information:
a type of a picture in which the current block is located;
a color component of the current block;
a size of the current block;
a vector resolution of the current block;
a vector difference of the current block;
a vector index of the current block; and
an IBC tool corresponding to an IBC prediction mode of the current block.

The embodiment of the decoder and the embodiment of the decoding method may correspond to each other, and for similar descriptions, reference may be made to the method embodiments. To avoid repetition, details are not described herein again. Specifically, the decoder shown in FIG. 15 may perform the foregoing embodiment of the decoding method. In addition, the foregoing and other operations and/or functions of the modules in the decoder are respectively configured for implementing the embodiment of the decoding method. For brevity, details are not described herein again.

FIG. 16 is a schematic structural diagram of an encoder 1600 according to an embodiment of this application. The encoder 1600 includes a first determining module 1610, a second determining module 1620, and a third determining module 1630.

The foregoing first determining module 1610 is configured to determine a target block, a prediction mode of the target block being IBC prediction. The foregoing second determining module 1620 is configured to determine target prediction information of the target block based on reconstruction information of an adjacent region of the target block and original prediction information of the target block. The foregoing third determining module 1630 is configured to determine reconstruction information of the target block based on the target prediction information.

In an exemplary embodiment, based on the foregoing solution, the foregoing second determining module 1620 includes a determining unit and a filter unit.

The foregoing determining unit is configured to determine a reference sample in the adjacent region of the target block based on position information of a target pixel in the target block, the target pixel being any pixel in the target block. The foregoing filter unit is configured to determine target prediction information of the target pixel based on reconstruction information of the reference sample and original prediction information of the target pixel, prediction information of the target block including the target prediction information of the target pixel.

In an exemplary embodiment, based on the foregoing solution, the foregoing determining unit is specifically configured to: determine, based on the position information of the target pixel in the target block, a first reference sample in a left adjacent region of the target block, and determine a second reference sample in an upper adjacent region of the target block. The foregoing filter unit is specifically configured to: determine an intra-prediction intermediate value of the target pixel based on first reconstruction information of the first reference sample and second reconstruction information of the second reference sample; and determine the target prediction information of the target pixel based on the intra-prediction intermediate value of the target pixel and the original prediction information of the target pixel; or determine the target prediction information of the target pixel based on the intra-prediction intermediate value of the target pixel, the original prediction information of the target pixel, and a filter coefficient.

In an exemplary embodiment, based on the foregoing solution, the size information of the target block is M×N, and the position information of the target pixel in the target block is (x, y), a value of x is being positive integer not greater than M, and a value of y is being positive integer not greater than N.

The first reference sample includes a first pixel related to a horizontal size N of the target block and a second pixel related to a vertical position y of the target pixel. The second reference sample includes a third pixel related to a vertical size M of the target block and a fourth pixel related to a horizontal position x of the target pixel.

The filter unit is further specifically configured to: determine an intra prediction vertical component of the target pixel based on reconstruction information of the first pixel, reconstruction information of the fourth pixel, the horizontal size N of the target block, and the vertical position y of the target pixel; determine an intra prediction horizontal component of the target pixel based on reconstruction information of the second pixel, reconstruction information of the third pixel, the vertical size M of the target block, and the horizontal position x of the target pixel; and determine the intra-prediction intermediate value of the target pixel based on the intra prediction vertical component and the intra prediction horizontal component.

In an exemplary embodiment, based on the foregoing solution, the determining unit is specifically configured to determine, based on the position information of the target pixel in the target block, a third reference sample in a left adjacent region of the target block, and determine a fourth reference sample in an upper adjacent region of the target block. The foregoing filter unit is specifically configured to: determine the target prediction information of the target pixel based on third reconstruction information of the third reference sample, fourth reconstruction information of the fourth reference sample, and the original prediction information of the target pixel; or determine the target prediction information of the target pixel based on the third reconstruction information of the third reference sample, the fourth reconstruction information of the fourth reference sample, the original prediction information of the target pixel, and a filter parameter.

In an exemplary embodiment, based on the foregoing solution, the filter parameter is related to at least one of the position information of the target pixel in the target block and the size information of the target block.

In an exemplary embodiment, based on the foregoing solution, the encoder further includes a writing module. The foregoing writing module is configured to write a first IBC flag of a first-level syntactic structure into the code stream, the first IBC flag being configured for indicating whether encoding information of the first-level syntactic structure uses the IBC mode, or configured for indicating whether the IBCPF mode is supported when the IBC mode is used.

In an exemplary embodiment, based on the foregoing solution, the encoder further includes a writing module. The foregoing writing module is configured to write a first IBC flag and a second IBC flag of a first-level syntactic structure into the code stream, the first IBC flag being configured for indicating whether encoding information of the first-level syntactic structure uses the IBC mode, and the second IBC flag being configured for indicating whether the encoding information of the first-level syntactic structure supports the IBCPF mode.

In an exemplary embodiment, based on the foregoing solution, the encoder further includes a writing module. The foregoing writing module is configured to write a third IBC flag of a second-level syntactic structure into the code stream, the third IBC flag being configured for indicating whether encoding information of the second-level syntactic structure uses the IBC mode, or configured for indicating whether the IBCPF mode is supported when the IBC mode is used.

In an exemplary embodiment, based on the foregoing solution, the encoder further includes a writing module. The foregoing writing module is configured to write a third IBC flag and a fourth IBC flag of a second-level syntactic structure into the code stream, the third IBC flag being configured for indicating whether encoding information of the second-level syntactic structure uses the IBC mode, and the fourth IBC flag being configured for indicating whether the encoding information of the second-level syntactic structure supports the IBCPF mode.

In an exemplary embodiment, based on the foregoing solution, the encoder further includes a writing module. The foregoing writing module is configured to write a fourth IBC flag of a second-level syntactic structure into the code stream, the fourth IBC flag being configured for indicating whether encoding information of the second-level syntactic structure supports an IBCPF mode.

In an exemplary embodiment, based on the foregoing solution, the second-level syntactic structure is frame-level, and the first-level syntactic structure is sequence-level; or the second-level syntactic structure is slice-level, and the first-level syntactic structure is frame-level or sequence-level; or the second-level syntactic structure is block-level, and the first-level syntactic structure is slice-level, frame-level, or sequence-level; or the first-level syntactic structure is block-level.

In an exemplary embodiment, based on the foregoing solution, the encoder further includes a writing module. The foregoing writing module is configured to write a block-level fifth IBC flag into a code stream, the fifth IBC flag being configured for indicating whether the current block supports an IBCPF mode, and different types of the supported IBCPF modes.

In an exemplary embodiment, based on the foregoing solution, the encoder further includes a writing module. The foregoing writing module is configured to write target information into a code stream, the target information being configured for determining whether the current block supports an IBCPF mode, and the target information including one or more of the following information:
a type of a picture in which the current block is located;
a color component of the current block;
a size of the current block;
a vector resolution of the current block;
a vector difference of the current block;
a vector index of the current block; and
an IBC tool corresponding to an IBC prediction mode of the current block.

The embodiment of the encoder and the embodiment of the encoding method may correspond to each other, and for similar descriptions, reference may be made to the method embodiments. To avoid repetition, details are not described herein again. Specifically, the encoder shown in FIG. 16 may perform the foregoing embodiment of the encoding method. In addition, the foregoing and other operations and/or functions of the modules in the encoder are respectively configured for implementing the embodiment of the encoding method. For brevity, details are not described herein again.

FIG. 17 is a schematic structural diagram of a codec system 1700 according to an embodiment of this application. As shown in FIG. 17, the codec system 1700 may include an encoder 1600 and a decoder 1500.

In the embodiments of this application, the encoder 1600 may be the encoder according to any one of the foregoing embodiments, and the decoder 1500 may be the decoder according to any one of the foregoing embodiments.

The apparatus in this embodiment of this application is described above from the perspective of functional modules with reference to the accompanying drawings. The functional modules may be implemented in a form of hardware, or may be implemented by using an instruction in a form of software, or may be implemented by using a combination of hardware and software modules. Specifically, the operations of the method embodiment of the embodiments of this application may be completed by using an integrated logic circuit of hardware in a processor and/or instructions in a form of software. The operations of the method disclosed with reference to the embodiments of this application may be directly performed by a hardware decoding processor, or may be performed and completed by a combination of hardware and software modules in the decoding processor. In some embodiments, a software module may be located in a mature storage medium in the art, such as a random access memory (RAM), a flash memory, a read-only memory (ROM), a programmable ROM, an electrically erasable programmable memory, or a register. The storage medium is located in the memory, and a processor reads information in the memory and completes the operations in the foregoing method embodiment in combination with hardware thereof.

FIG. 18 is a schematic structural diagram of an electronic device 1800 according to an embodiment of this application. The electronic device of FIG. 18 may be configured to perform the foregoing decoding method, and may also be configured to perform the foregoing encoding method.

As shown in FIG. 18, the electronic device 1800 may include:
a memory 1810 and a processor 1820. The memory 1810 is configured to store a computer program 1830 and transmit the computer program 1830 to the processor 1820. In other words, the processor 1820 may invoke the computer program 1830 from the memory 1810 and run the computer program to implement the method in the embodiments of this application.

For example, the processor 1820 may be configured to perform the operations in the foregoing method based on instructions in the computer program 1830.

In some embodiments of this application, the processor 1820 may include, but is not limited to:
a general-purpose processor, a digital signal processor (DSP), an application specific integrated circuit (ASIC), a field programmable gate array (FPGA) or another programmable logic device, a discrete gate or a transistor logic device, a discrete hardware component, or the like.

In some embodiments of this application, the memory 1810 includes, but is not limited to:
a volatile memory and/or a non-volatile memory. The non-transitory memory may be a ROM, a programmable read-only memory (PROM), an erasable programmable read-only memory (EPROM), an electrically erasable programmable read-only memory (EEPROM), or a flash memory. The volatile memory may be a RAM, which serves as an external cache. By way of example but not limitation, many forms of RAMs, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM) may be used.

In some embodiments of this application, the computer program 1830 may be divided into one or more modules. The one or more modules are stored in the memory 1810, and are executed by the processor 1820 to complete the decoding method or the encoding method of this application. The one or more modules may be a series of computer program instruction sections that can implement specific functions. The instruction sections are configured for describing an execution process of the computer program 1830 in the electronic device.

As shown in FIG. 18, the electronic device 30 may further include:
a transceiver 1840. The transceiver 1840 may be connected to the processor 1820 or the memory 1810.

The processor 1820 may control the transceiver 1840 to communicate with another device, and specifically, may transmit information or data to another device, or receive information or data transmitted by another device. The transceiver 1840 may include a transmitter and a receiver. The transceiver 1840 may further include an antenna. One or more antennas may be arranged.

The components of the electronic device 30 are connected through a bus system. In addition to a data bus, the bus system further includes a power bus, a control bus, and a state signal bus.

According to an aspect of this application, a computer storage medium is provided, having a computer program stored therein, the computer program, when executed by a computer, causing the computer to perform the method in the foregoing method embodiment. Alternatively, an embodiment of this application further provides a computer program product, including instructions, the instructions, when executed by a computer, causing the computer to perform the method in the foregoing method embodiment.

According to an aspect of this application, a computer program product or a computer program is provided, the computer program product or the computer program including a computer instruction, the computer instruction being stored in a computer-readable storage medium. The processor of the computer device is configured to read the computer instruction from the computer-readable storage medium. The processor is configured to execute the computer instruction, to cause the computer device to perform the method in the foregoing method embodiments.

In other words, when the embodiments are implemented by using software, all or some of the embodiments may be implemented in a form of a computer program product. The computer program product includes one or more computer instructions. When the computer program instructions are loaded and executed on a computer, all or some of the processes or functions according to the embodiments of this application are generated. The computer may be a general-purpose computer, a dedicated computer, a computer network, or another programmable apparatus. The computer instruction may be stored in the computer-readable storage medium, or may be transmitted from a computer-readable storage medium to another computer-readable storage medium. For example, the computer instruction may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner). The computer-readable storage medium may be any usable medium that may be accessed by the computer, or a data storage device such as a server or a data center in which one or more usable mediums are integrated. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art may be aware that, in combination with the examples described in the embodiments disclosed in this specification, modules and algorithm operations may be implemented by electronic hardware or a combination of computer software and electronic hardware. Whether these functions are performed by hardware or software depends on specific applications and design constraints of the technical solutions. A person skilled in the art may use different methods to implement the described functions for each specific application, but it is not to be considered that the implementation goes beyond the scope of this application.

In the embodiments provided in this application, the disclosed system, apparatus, and method may be implemented in another manner. For example, the apparatus embodiment described above is merely exemplary. For example, division into the modules is merely logical function division, and may be other division during actual implementation. For example, a plurality of modules or components may be combined or integrated into another system, or some features may be ignored or not executed. In addition, the displayed or discussed mutual coupling or direct coupling or communication connection may be implemented through some interfaces. The indirect coupling or communication connection between the apparatuses or modules may be implemented in an electronic, mechanical, or another form.

The modules described as separate components may or may not be physically separated, and the components displayed as modules may or may not be physical modules. They may be located in one place, or may be distributed over a plurality of network units. Some or all of the modules may be selected based on actual demands to achieve the objectives of the solutions of the embodiments. For example, the functional modules in the embodiments of this application may be integrated into one processing module, each of the modules may exist alone physically, or two or more modules may be integrated into one module.

The foregoing descriptions are merely specific implementations of this application, and are not intended to limit the protection scope of this application. Any variation or replacement readily figured out by a person skilled in the art within the technical scope disclosed in this application falls within the protection scope of this application. Therefore, the protection scope of this application shall be subject to the protection scope of the claims.

What is claimed is:

1. A video decoding method comprising:
parsing a code stream to determine a target block;
in accordance with a determination that a prediction mode of the target block is intra block copy (IBC) prediction:
determining target prediction information of the target block based on reconstruction information of an adjacent region of the target block and original prediction information of the target block; and
determining reconstruction information of the target block based on the target prediction information.

2. The method according to claim 1, wherein the determining target prediction information of the target block based on reconstruction information of an adjacent region of the target block and original prediction information of the target block comprises:
determining a reference sample in the adjacent region of the target block based on position information of a target pixel in the target block, the target pixel being any pixel in the target block; and
determining target prediction information of the target pixel based on reconstruction information of the reference sample and original prediction information of the target pixel, prediction information of the target block comprising the target prediction information of the target pixel.

3. The method according to claim 2, wherein the determining a reference sample in the adjacent region of the target block based on position information of a target pixel in the target block comprises:
determining, based on the position information of the target pixel in the target block, a first reference sample in a left adjacent region of the target block, and determining a second reference sample in an upper adjacent region of the target block; and
the determining target prediction information of the target pixel based on reconstruction information of the reference sample and original prediction information of the target pixel comprises:
determining an intra-prediction intermediate value of the target pixel based on first reconstruction information of the first reference sample and second reconstruction information of the second reference sample; and
determining the target prediction information of the target pixel based on the intra-prediction intermediate value of the target pixel and the original prediction information of the target pixel; or determining the target prediction information of the target pixel based on the intra-prediction intermediate value of the target pixel, the original prediction information of the target pixel, and a filter coefficient.

4. The method according to claim 3, wherein size information of the target block is M×N, and the position information of the target pixel in the target block is (x, y), a value of x being a positive integer not greater than M, a value of y being a positive integer not greater than N, and values of M and N being positive integers;
the first reference sample comprises a first pixel related to a horizontal size N of the target block, and a second pixel related to a vertical position y of the target pixel;
the second reference sample comprises a third pixel related to a vertical size M of the target block, and a fourth pixel related to a horizontal position x of the target pixel; and
the determining an intra-prediction intermediate value of the target pixel based on first reconstruction information of the first reference sample and second reconstruction information of the second reference sample comprises:
determining an intra prediction vertical component of the target pixel based on reconstruction information of the first pixel, reconstruction information of the fourth pixel, the horizontal size N of the target block, and the vertical position y of the target pixel;
determining an intra prediction horizontal component of the target pixel based on reconstruction information of the second pixel, reconstruction information of the third pixel, the vertical size M of the target block, and the horizontal position x of the target pixel; and
determining the intra-prediction intermediate value of the target pixel based on the intra prediction vertical component and the intra prediction horizontal component.

5. The method according to claim 2, wherein the determining a reference sample in the adjacent region of the target block based on position information of a target pixel in the target block comprises:
determining, based on the position information of the target pixel in the target block, a third reference sample in a left adjacent region of the target block, and determining a fourth reference sample in an upper adjacent region of the target block; and
the determining target prediction information of the target pixel based on reconstruction information of the reference sample and original prediction information of the target pixel comprises:
determining the target prediction information of the target pixel based on third reconstruction information of the third reference sample, fourth reconstruction information of the fourth reference sample, and the original prediction information of the target pixel; or determining the target prediction information of the target pixel based on the third reconstruction information of the third reference sample, the fourth reconstruction information of the fourth reference sample, the original prediction information of the target pixel, and a filter parameter.

6. The method according to claim 5, wherein the filter parameter is a function of at least one of the position information of the target pixel in the target block and the size information of the target block.

7. The method according to claim 1, wherein the parsing a code stream, to determine a target block comprises:
parsing the code stream, to obtain a first IBC flag of a first-level syntactic structure, the first IBC flag being configured for indicating whether encoding information of the first-level syntactic structure of the code stream uses an IBC mode, and configured for indicating whether an intra block copy prediction filter (IBCPF) mode is supported when the IBC mode is used;
determining that the encoding information of the first-level syntactic structure does not comprise the target block when the first IBC flag indicates that the encoding information of the first-level syntactic structure does not use the IBC mode, or when the first IBC flag indicates that the encoding information of the first-level syntactic structure uses the IBC mode and does not support the IBCPF mode; and
determining whether the first-level syntactic structure is block-level when the first IBC flag indicates that the encoding information of the first-level syntactic structure uses the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

8. The method according to claim 1, wherein the parsing a code stream to determine a target block comprises:
parsing the code stream, to obtain a first IBC flag of a first-level syntactic structure, the first IBC flag being configured for indicating whether encoding information of the first-level syntactic structure in the code stream uses an IBC mode;
determining that the encoding information of the first-level syntactic structure does not comprise the target block when the first IBC flag indicates that the encoding information of the first-level syntactic structure does not use the IBC mode;
parsing the code stream, to obtain a second IBC flag of the first-level syntactic structure when the first IBC flag indicates that the encoding information of the first-level syntactic structure uses the IBC mode, the second IBC flag being configured for indicating whether the encoding information of the first-level syntactic structure in the code stream supports an IBCPF mode;
determining that the encoding information of the first-level syntactic structure does not comprise the target block when the second IBC flag indicates that the encoding information of the first-level syntactic structure does not support use of the IBCPF mode; and
determining whether the first-level syntactic structure is block-level when the second IBC flag indicates that the encoding information of the first-level syntactic structure supports the use of the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

9. The method according to claim 1, wherein the parsing a code stream to determine a target block comprises:
parsing the code stream to obtain a block-level fifth IBC flag, the fifth IBC flag being configured for indicating whether the current block supports an IBCPF mode, and different types of the supported IBCPF modes;
determining that the current block is not the target block when the fifth IBC flag indicates that the current block does not support the IBCPF mode; and
determining the current block as the target block when the fifth IBC flag indicates that the current block supports any type of IBCPF mode.

10. The method according to claim 1, wherein the parsing a code stream to determine a target block comprises:
parsing the code stream to obtain target information, and determining whether the current block supports the IBCPF mode based on the target information; and
determining that the current block is the target block when it is determined that the current block supports the IBCPF mode,
the target information comprising one or more of the following information:
a type of a picture in which the current block is located;
a color component of the current block;
a size of the current block;
a vector resolution of the current block;
a vector difference of the current block;
a vector index of the current block; and
an IBC tool corresponding to an IBC prediction mode of the current block.

11. An electronic device, comprising a processor and a memory,
the memory being configured to store a computer program; and
the processor being configured to execute the computer program to implement a video decoding method including:
parsing a code stream to determine a target block;
in accordance with a determination that a prediction mode of the target block is intra block copy (IBC) prediction:
determining target prediction information of the target block based on reconstruction information of an adjacent region of the target block and original prediction information of the target block; and
determining reconstruction information of the target block based on the target prediction information.

12. The electronic device according to claim 11, wherein the determining target prediction information of the target block based on reconstruction information of an adjacent region of the target block and original prediction information of the target block comprises:
determining a reference sample in the adjacent region of the target block based on position information of a target pixel in the target block, the target pixel being any pixel in the target block; and
determining target prediction information of the target pixel based on reconstruction information of the reference sample and original prediction information of the target pixel, prediction information of the target block comprising the target prediction information of the target pixel.

13. The electronic device according to claim 11, wherein the parsing a code stream, to determine a target block comprises:
parsing the code stream, to obtain a first IBC flag of a first-level syntactic structure, the first IBC flag being configured for indicating whether encoding information of the first-level syntactic structure of the code stream uses an IBC mode, and configured for indicating whether an intra block copy prediction filter (IBCPF) mode is supported when the IBC mode is used;
determining that the encoding information of the first-level syntactic structure does not comprise the target block when the first IBC flag indicates that the encoding information of the first-level syntactic structure does not use the IBC mode, or when the first IBC flag indicates that the encoding information of the first-level syntactic structure uses the IBC mode and does not support the IBCPF mode; and
determining whether the first-level syntactic structure is block-level when the first IBC flag indicates that the encoding information of the first-level syntactic structure uses the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

14. The electronic device according to claim 11, wherein the parsing a code stream to determine a target block comprises:
parsing the code stream, to obtain a first IBC flag of a first-level syntactic structure, the first IBC flag being configured for indicating whether encoding information of the first-level syntactic structure in the code stream uses an IBC mode;
determining that the encoding information of the first-level syntactic structure does not comprise the target block when the first IBC flag indicates that the encoding information of the first-level syntactic structure does not use the IBC mode;
parsing the code stream, to obtain a second IBC flag of the first-level syntactic structure when the first IBC flag indicates that the encoding information of the first-level syntactic structure uses the IBC mode, the second IBC flag being configured for indicating whether the encoding information of the first-level syntactic structure in the code stream supports an IBCPF mode;
determining that the encoding information of the first-level syntactic structure does not comprise the target block when the second IBC flag indicates that the encoding information of the first-level syntactic structure does not support use of the IBCPF mode; and
determining whether the first-level syntactic structure is block-level when the second IBC flag indicates that the encoding information of the first-level syntactic structure supports the use of the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

15. The electronic device according to claim 11, wherein the parsing a code stream to determine a target block comprises:
parsing the code stream to obtain a block-level fifth IBC flag, the fifth IBC flag being configured for indicating whether the current block supports an IBCPF mode, and different types of the supported IBCPF modes;
determining that the current block is not the target block when the fifth IBC flag indicates that the current block does not support the IBCPF mode; and
determining the current block as the target block when the fifth IBC flag indicates that the current block supports any type of IBCPF mode.

16. The electronic device according to claim 11, wherein the parsing a code stream to determine a target block comprises:
parsing the code stream to obtain target information, and determining whether the current block supports the IBCPF mode based on the target information; and
determining that the current block is the target block when it is determined that the current block supports the IBCPF mode,
the target information comprising one or more of the following information:
a type of a picture in which the current block is located;
a color component of the current block;
a size of the current block;
a vector resolution of the current block;
a vector difference of the current block;
a vector index of the current block; and
an IBC tool corresponding to an IBC prediction mode of the current block.

17. A non-transitory computer-readable storage medium storing a code stream that is configured to be decoded by a video decoding method, the video decoding method comprising:
the computer program causing an electronic device to perform a video decoding method including:
parsing the code stream to determine a target block;
in accordance with a determination that a prediction mode of the target block is intra block copy (IBC) prediction:
determining target prediction information of the target block based on reconstruction information of an adjacent region of the target block and original prediction information of the target block; and
determining reconstruction information of the target block based on the target prediction information.

18. The non-transitory computer-readable storage medium according to claim 17, wherein the determining target prediction information of the target block based on reconstruction information of an adjacent region of the target block and original prediction information of the target block comprises:
determining a reference sample in the adjacent region of the target block based on position information of a target pixel in the target block, the target pixel being any pixel in the target block; and
determining target prediction information of the target pixel based on reconstruction information of the reference sample and original prediction information of the target pixel, prediction information of the target block comprising the target prediction information of the target pixel.

19. The non-transitory computer-readable storage medium according to claim 17, wherein the parsing a code stream, to determine a target block comprises:
parsing the code stream, to obtain a first IBC flag of a first-level syntactic structure, the first IBC flag being configured for indicating whether encoding information of the first-level syntactic structure of the code stream uses an IBC mode, and configured for indicating whether an intra block copy prediction filter (IBCPF) mode is supported when the IBC mode is used;
determining that the encoding information of the first-level syntactic structure does not comprise the target block when the first IBC flag indicates that the encoding information of the first-level syntactic structure does not use the IBC mode, or when the first IBC flag indicates that the encoding information of the first-level syntactic structure uses the IBC mode and does not support the IBCPF mode; and
determining whether the first-level syntactic structure is block-level when the first IBC flag indicates that the encoding information of the first-level syntactic structure uses the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.

20. The non-transitory computer-readable storage medium according to claim 17, wherein the parsing a code stream to determine a target block comprises:
parsing the code stream, to obtain a first IBC flag of a first-level syntactic structure, the first IBC flag being configured for indicating whether encoding information of the first-level syntactic structure in the code stream uses an IBC mode;
determining that the encoding information of the first-level syntactic structure does not comprise the target block when the first IBC flag indicates that the encoding information of the first-level syntactic structure does not use the IBC mode;
parsing the code stream, to obtain a second IBC flag of the first-level syntactic structure when the first IBC flag indicates that the encoding information of the first-level syntactic structure uses the IBC mode, the second IBC flag being configured for indicating whether the encoding information of the first-level syntactic structure in the code stream supports an IBCPF mode;
determining that the encoding information of the first-level syntactic structure does not comprise the target block when the second IBC flag indicates that the encoding information of the first-level syntactic structure does not support use of the IBCPF mode; and
determining whether the first-level syntactic structure is block-level when the second IBC flag indicates that the encoding information of the first-level syntactic structure supports the use of the IBC mode and supports the IBCPF mode; determining a current block as the target block when the first-level syntactic structure is block-level; and parsing the code stream to obtain a flag of a next-level syntactic structure when the first-level syntactic structure is not block-level, to determine the target block based on the flag of the next-level syntactic structure.
